(19) United States
(12) Patent Application Publication
(10) Pub. No.: US 2010/0110351 A1
(43) Pub. Date: May 6, 2010

(54) TRANSFLECTIVE LIQUID CRYSTAL DISPLAYS

(76) Inventors: Hyang-Yul Kim, Oviedo, FL (US); Zhibing Ge, Orlando, FL (US); Seung-Hee Lee, Oviedo, FL (US); Shin-Tson Wu, Oviedo, FL (US); Wang-Yang Li, Xinhua Town (TW); Chung-Kuang Wei, Taipei City (TW)

Correspondence Address: FISH & RICHARDSON PC, P.O. BOX 1022, MINNEAPOLIS, MN, 55440-1022, US

(21) Appl. No.: 12/264,088

(22) Filed: Nov. 3, 2008

(51) Int. Cl. G02F 1/1335; G02F 1/1337

(52) U.S. Cl. 349/114; 349/128

(57) ABSTRACT

A liquid crystal display includes pixels, each pixel including a transmissive region and a reflective region. The transmissive region has a liquid crystal layer having a homogeneous alignment, and the reflective region has a liquid crystal layer having a hybrid alignment. In the transmissive region, an alignment layer, a common electrode, and a pixel electrode are on a same side of the liquid crystal layer. In the reflective region, an alignment layer, a common electrode, and a reflective pixel electrode are on a same side of the liquid crystal layer. The alignment layer of the reflective region has an alignment direction that is different from that of the alignment layer of the transmissive region.

### PARTIES TO A JOINT RESEARCH AGREEMENT

At least some of the subject matter disclosed in this patent application was developed under a joint research agreement between Chi Mei Optoelectronics Corporation and the University of Central Florida.

### BACKGROUND

This description relates to transflective liquid crystal displays.

A transflective liquid crystal display (TR-LCD) includes transmissive (T) and reflective (R) sub-pixels. In some examples, a backlight unit is used to illuminate rendered images when the display is operating in the T mode, and ambient light is used when operating in the R mode. Backlight passes the liquid crystal (LC) layer once, while the ambient light traverses the liquid crystal layer twice.

FIG. 1 is a cross-sectional view of an example pixel region of a transflective LCD device 8 having a dual cell gap configuration. The transflective LCD device 8 includes an upper substrate 10 (color filter substrate), a lower substrate 20 (TFT array substrate), and a liquid crystal layer 30 between the substrates 10 and 20. A color resin layer 11 and an upper transparent electrode 12 acting as a common electrode are formed on an inner surface of the upper substrate 10. An upper polarizer 14 and a retardation film 13 acting as a quarter-wave plate are formed on an outer surface of the upper substrate 10. The inner surface refers to the surface that is closer to the liquid crystal layer 30, and the outer surface refers to the surface that is farther away from the liquid crystal layer 30.

An insulating layer 21, a lower transparent electrode 22 acting as a pixel electrode, a patterned passivation layer 23, and a reflective pixel electrode 24 are sequentially formed on a surface of the lower substrate 20. A lower polarizer 25 is formed on another surface of the lower substrate 20. The T sub-pixel has a first cell gap d₁ between the upper transparent electrode 13 and the lower transparent electrode 22, whereas the R sub-pixel has a second cell gap d₂ between the upper transparent electrode 13 and the reflective pixel electrode 24. In this example, the first cell gap d₁ is about twice as large as the second cell gap d₂ such that incident rays of light have about the same phase retardation for the transmissive and reflective modes.

FIG. 2 is a cross-sectional view of an example pixel region of a transflective LCD 74 that includes a TFT substrate 70, a color filter substrate 80, and a liquid crystal layer 90 between the substrates 70 and 80. A common electrode 71, a reflector 72, and a comb-like pixel electrode 73 are formed on the TFT substrate 70. A color filter layer 81 and an in-cell retarder 82 are formed on the color filter substrate 80. The transflective LCD 74 incorporates a double cell gap configuration in which the transmissive and reflective regions have different cell gaps.

### SUMMARY OF THE INVENTION

A single cell gap fringe field switching (FFS) based transflective LCD using a negative dielectric anisotropic liquid crystal material is provided. A homogeneous alignment is used for the transmissive regions, and a hybrid alignment configuration is used for the reflective regions. A “pixel common inversion” (PCI) electrode structure is used in which the common electrode is placed between the liquid crystal layer and the pixel electrode.

In general, in one aspect, a liquid crystal display includes an upper substrate; a lower substrate that is closer to a backlight unit than the upper substrate; and a liquid crystal layer between the lower and upper substrates, the liquid crystal layer including liquid crystal molecules having a negative dielectric anisotropy. The display includes pixels between the upper and lower substrates, each pixel having a transmissive region and a reflective region in which the transmissive region has a cell gap substantially the same as the cell gap of the reflective region, the transmissive region having a transparent pixel electrode, the reflective region having a reflective pixel electrode. The display includes an upper alignment layer between the upper glass substrate and the liquid crystal layer; and a lower alignment layer between the lower substrate and the liquid crystal layer, the upper and lower alignment layers oriented such that the liquid crystal molecules are homogeneously aligned in the transmissive region, and the liquid crystal molecules have a hybrid alignment in the reflective region in which liquid crystal molecules closer to the lower substrate are aligned in a direction different from the liquid crystal molecules closer to the upper substrate. The display includes a common electrode in which the common electrode and the pixel electrode are at a same side relative to the liquid crystal layer, and the orientation of the liquid crystal molecules are controlled based on fringe electric fields generated by the pixel and common electrodes when a voltage difference is applied between the pixel electrode and the common electrode.

Implementations can include one or more of the following features. In the transmissive region, the common electrode is between the liquid crystal layer and the transparent pixel electrode, and in the reflective region, the common electrode is between the liquid crystal layer and the reflective pixel electrode. The transparent pixel electrode and the reflective pixel electrode are electrically connected and receive a pixel voltage that corresponds to a gray level to be shown by the pixel. A first linear polarizer is coupled to the lower substrate, and a second linear polarizer is coupled to the upper substrate, in which the transmission axis of the first and second linear polarizers are substantially perpendicular to each other. In the transmissive region the alignment directions of the upper and lower alignment layers are substantially parallel to the transmission axis of one of the first and second linear polarizers, and the alignment direction of the lower alignment layer in the reflective region is at an angle in a range of 30° to 60° with respect to the transmission axis of one of the first and second linear polarizers. The common electrode and the pixel electrode include indium-tin-oxide. The common electrode in the transmissive region includes stripes, the common electrode in the reflective region includes stripes, and the stripes of the common electrode in the transmissive region are at an angle in a range of 120° to 160° relative to the stripes of the common electrode in the reflective region.

The common electrode in the reflective region includes stripes each having a width in a range from 1 to 3 μm and a spacing between stripes in a range from 2 to 4 μm, and the common electrode in the transmissive region includes stripes each having a width in a range from 2 to 4 μm and a spacing between stripes in a range from 4 to 6 μm. The display includes data bus lines made of conductive metals including MoW, an alloy Al—Nd, or a stacked layer of Mo/Al materials, each data bus line having a chevron shape in a pixel region and is covered and electrically shielded by a common electrode stripe from the liquid crystal layer. In the transmissive region, the common electrode includes stripes, and the surface alignment direction of the liquid crystal layer is at an angle in a range between 5° to 20° with respect to a direction perpendicular to the common electrode stripes. In the transmissive region, the surface pretilt angle on both the upper and the lower substrate is between 0° to 10° relative to the substrate surface. In the reflective region, the common electrode includes stripes, the surface alignment direction of the liquid crystal layer on the lower substrate is at an angle in a range between 5° to 20° with respect to a direction perpendicular to the common electrode stripes, the surface pre-tilt angle of the liquid crystal layer on the upper substrate is in a range between 85° to 90° relative to a surface of the upper substrate. In the reflective region, the surface pretilt angle on the lower substrate is between 0° to 10° relative to the lower substrate. A black matrix is formed on the upper substrate covering a thin film transistor area and a boundary area between the transmissive region and the reflective region. The liquid crystal display includes a barrier wall between the transmissive region and the reflective region. The barrier wall has a height substantially the same as the thickness of the liquid crystal layer and defines a cell gap of the liquid crystal layer.

In general, in another aspect, a display includes a pixel having a transmissive region and a reflective region. The transmissive region has a liquid crystal layer, a transparent pixel electrode, and a common electrode. The liquid crystal layer is between a first substrate and a second substrate, and includes liquid crystal molecules that are aligned substantially along a same direction when the pixel is in a dark state. The transparent pixel electrode and the common electrode are at a same side relative to the liquid crystal layer, and orientation of the liquid crystal molecules is controlled based on fringe electric fields generated by the transparent pixel electrode and common electrode when a voltage difference is applied between the transparent pixel electrode and the common electrode. The reflective region has a liquid crystal layer, a reflective pixel electrode, and a common electrode. The liquid crystal layer is between the first substrate and the second substrate, and has a hybrid alignment in which liquid crystal molecules closer to the first substrate are aligned in a direction different from the liquid crystal molecules closer to the second substrate when the pixel is in the dark state. The reflective pixel electrode and the common electrode are at the same side relative to the liquid crystal layer such that orientation of the liquid crystal molecules is controlled based on fringe electric fields generated from the reflective pixel electrode when a voltage difference is applied between the reflective pixel electrode and the common electrode.

Implementations can include one or more of the following features. The common electrode of the transmissive region is electrically coupled to the common electrode of the reflective region. The transparent pixel electrode of the transmissive region is electrically coupled to the reflective pixel electrode of the reflective region. The display includes a plurality of pixels in which the common electrodes of different pixels are electrically connected together. The common electrode is between the transparent pixel electrode and the liquid crystal layer. The common electrode includes stripes.

In general, in another aspect, a transflective liquid crystal display includes a backlight unit, an upper substrate, a lower substrate that is closer to the backlight unit relative to the upper substrate, and a liquid crystal layer between the lower and upper substrates, the liquid crystal layer including a liquid crystal material having a negative dielectric anisotropy. The display includes a first linear polarizer, a second linear polarizer having a transmission axis that is perpendicular to that of the first linear polarizer, the upper and lower substrates being between the first and second linear polarizers, and a plurality of pixels between the upper and lower substrates. Each pixel has a transmissive region and a reflective region, the liquid crystal cell gap in the transmissive region being substantially the same as the cell gap in the reflective region, the liquid crystal molecules being homogeneously aligned in the transmissive region and having a hybrid alignment in the reflective region, the alignment direction of the liquid crystal layer on upper and lower substrate surfaces in the transmissive region being substantially parallel to the transmission axis of one of the first and second linear polarizers, and the alignment direction of the liquid crystal layer on the lower glass substrate in the reflective region being aligned at an angle in a range between 30° to 60° with respect to the transmission axis of one of the first and second linear polarizers. Each pixel includes a transparent pixel electrode in the transmissive region, a reflective pixel electrode in the reflective region, and a common electrode having many stripes, in which a driving voltage is applied between the pixel electrode and the common electrode and between the reflective pixel electrode and the common electrode to reorient liquid crystal molecules to cause the pixel to show various gray levels.

Implementations can include one or more of the following features. Each pixel includes a barrier wall at a boundary area between the transmissive region and the reflective region to reduce light leakage, the barrier wall extending into the liquid crystal layer. The barrier wall includes color resin. The barrier wall is made of two overlapping color resin layers having two colors that are different from the pixel color. For example, the barrier wall in a red pixel includes blue and green color resin. The barrier wall includes an over coating dielectric layer. The barrier wall has a height in a range from 0.4 to 3.2 μm and a width in a range from 3 to 20 μm. The barrier wall has a height that is substantially the same as the thickness of the liquid crystal layer and defines a cell gap of the liquid crystal layer. The first and third transparent electrodes include indium-tin-oxide. The stripes of the common electrode in the transmissive region and the stripes of the common electrode in the reflective region have a chevron geometry. The chevron geometry has a chevron angle in a range between 120° to 160°. In the reflective region the stripes of the common electrode each has an electrode width in a range from 1 to 3 μm, and an electrode spacing in a range from 2 to 4 μm, and in the transmission region the electrode stripes each has an electrode width in a range from 2 to 4 μm and an electrode spacing in a range from 4 to 6 μm. The liquid crystal display includes a data bus line made of conductive metals including MoW, an alloy Al—Nd, or a stacked layer of Mo/Al materials. The liquid crystal display includes data bus lines each having a chevron shape in each pixel region. Each data bus line is covered and electrically shielded by a common electrode stripe from the liquid crystal layer. The surface alignment direction of the liquid crystal layer in the transmissive region has an angle in a range from 5° to 20° with respect to a direction that is perpendicular to the common electrode stripes. In the transmissive region, the surface pretilt angles of the liquid crystal layer on both the lower and upper substrates are in a range between 0° to 10° relative to respective substrate surfaces. A surface alignment direction of the liquid crystal layer on the lower substrate in the reflective region has an angle in a range from 5° to 20° with respect to a direction that is perpendicular to the common electrode stripes, and a surface pre-tilt angle of the liquid crystal layer on the upper substrate in the reflective region is in a range from 85° to 90°. In the reflective region, the surface pretilt angle of the liquid crystal layer on the lower substrate is in a range between 0° to 10° relative to the lower substrate surface.

In general, in another aspect, a method of fabricating a transflective liquid crystal display includes using a first mask to define a gate line and a gate electrode; using a second mask to define an active layer for a thin film transistor; using a third mask to define an embossing pattern for a reflective pixel electrode; using a fourth mask to define a pixel electrode; using a fifth mask to define a source electrode, a drain electrode, and a data bus line; using a sixth mask to define gate, source, and drain pad contact windows; and using a seventh mask to define a common electrode having a chevron geometry and having openings to facilitate generation of fringe fields during operation of the display.

Implementations can include one or more of the following features. A barrier wall is formed between the transmissive region and the reflective region at the same time that a color filter layer is formed. An eighth mask is used to define an alignment direction of an alignment layer for aligning, in a reflective region, liquid crystal molecules near a lower substrate that is closer to a backlight module that an upper substrate, the alignment direction of the alignment layer in the reflective region being at an angle in a range between 30° to 60° with respect to a transmission axis of a linear polarizer used in the display.

In general, in another aspect, a liquid crystal display includes pixels, each pixel including a transmissive region and a reflective region. The transmissive region has a liquid crystal layer having a homogeneous alignment, the transmissive region having an alignment layer, a common electrode, and a pixel electrode that are on a same side of the liquid crystal layer. The reflective region has a liquid crystal layer having a hybrid alignment, the reflective region having an alignment layer, a common electrode, and a reflective pixel electrode that are on a same side of the liquid crystal layer, in which the alignment layer of the reflective region has an alignment direction that is different from that of the alignment layer of the transmissive region.

Implementations can include one or more of the following features. The alignment layer of the transmissive region has an alignment direction that is between 30° to 60° relative to that of the alignment layer of the reflective region. The alignment directions of the upper and lower alignment layers in the transmissive region are substantially parallel to the transmission axis of a first linear polarizer or a second linear polarizer, the pixels being between the first and second linear polarizers. In the transmissive region, the common electrode is between the pixel electrode and the liquid crystal layer. In the reflective region, the common electrode is between the reflective pixel electrode and the liquid crystal layer. The common electrode includes stripes in the transmissive region and the reflective region. The common electrode stripes in the reflective region extend along a first direction, and the common electrode stripes in the transmissive region extends along a second direction that is different from the first direction. The first direction is at an angle between 20° to 60° relative to the second direction. The common electrode stripes in the reflective region have a stripe width and a stripe spacing that are different from those of the common electrode stripes in the transmissive region. The reflective and transmissive regions have common electrode stripes with stripe widths and stripe spacing that are configured to cause a voltage-transmittance curve to match a voltage-reflectance curve. When a pixel voltage corresponding to a dark state is applied between the reflective pixel electrode and the common electrode, the liquid crystal layer in the reflective region functions as a quarter wave plate. When a pixel voltage corresponding to a bright state is applied between the reflective pixel electrode and the common electrode, the liquid crystal layer in the reflective region is driven to have its effective optic axis rotated about 45° away from its initial alignment direction. In the reflective region, a lower portion of the liquid crystal layer has a surface pretilt angle between 0° to 10° relative to a lower substrate, and an upper portion of the liquid crystal layer has a surface pretilt angle between 85° to 90° relative to an upper substrate.

In general, in another aspect, a transflective liquid crystal display includes pixels, each pixel including a transmissive sub-pixel; a reflective sub-pixel; and a barrier wall between the transmissive sub-pixel and the reflective sub-pixel, the barrier wall extending into a liquid crystal layer of the pixel.

Implementations can include one or more of the following features. The barrier wall includes color resin. The color resin of the barrier wall includes a same material as that in a color filter used in the display. The barrier wall includes a dielectric layer. The barrier wall has a height that is between 10% to 90% of a cell gap of a liquid crystal layer of the pixel. The barrier wall has a width that is between 3 to 20 microns.

In general, in another aspect, a method of fabricating a liquid crystal display includes, in a transmissive region of a pixel, forming a pixel electrode above a first substrate; in a reflective region of the pixel, forming a reflective pixel electrode above the first substrate; forming a passivation layer above the pixel electrode and the reflective pixel electrode; forming a common electrode above the passivation layer; configuring alignment layers in the transmissive region of the pixel to cause liquid crystal molecule to be homogeneously aligned in the transmissive region; and configuring alignment layers in the reflective region of the pixel to cause liquid crystal molecules to have a hybrid alignment in the reflective region.

Implementations can include one or more of the following features. Configuring alignment layers in the transmissive and reflective regions includes using a first photomask to expose a first portion of an alignment layer in the transmissive region to cause the first portion of the alignment layer to have a first alignment direction, and using a second photomask to expose a second portion of the alignment layer in the reflective region to cause the second portion of the alignment layer to have a second alignment direction. The first direction is at an angle in a range between 30° to 60° relative to the second direction. Configuring alignment layers in the transmissive and reflective regions includes rubbing a portion of an alignment layer in the transmissive region to have a first alignment direction by using a first mask that exposes the portion of the alignment layer in the transmissive region and covers a portion of the alignment layer in the reflective region, and rubbing a portion of the alignment layer in the reflective region to have a second alignment direction by using a second mask that exposes the portion of the alignment layer in the reflective region and covers the portion of the alignment layer in the transmissive region. The first direction is at an angle in a range between 30° to 60° relative to the second direction.

Other aspects can include other combinations of the features recited above and other features, expressed as methods, apparatus, systems, program products, and in other ways.

Advantages of the aspects and implementations may include one or more of the following. The transflective display can be used in mobile devices, can have good sun light readability, low power consumption, thin profile, light weight, high resolution, wide viewing angle, high brightness, and low manufacturing cost. The transflective display does not need an in-cell retarder and can still achieve a good dark state. The driving voltages can be reduced by use of the pixel common inversion electrode structure. When color filter materials are used to construct barrier walls, light leakage can be reduced, resulting in a darker dark state, while not requiring additional fabrication steps.

### BRIEF DESCRIPTION OF THE FIGURES

FIGS. 1 and 2 are cross-sectional views of example transflective LCDs having dual cell gap configurations.

FIG. 3 is a cross-sectional view of an example single cell gap transflective LCD in a dark-state.

FIG. 4 is a cross-sectional view of an example single cell gap transflective LCD in a bright-state.

FIG. 5 is a flow diagram of an example process for fabricating a transflective LCD.

FIG. 6A is a top view of an example sub-pixel of a transflective LCD.

FIG. 6B is a top view of an example common electrode.

FIG. 7A is a cross sectional view of an example TFT area along a line A-A′ in the sub-pixel of FIG. 6.

FIG. 7B is a cross sectional view of an example data bus line area along a line B-B′ in the reflective region of FIG. 6.

FIG.7C is a cross sectional view of an example data bus line area along a line C-C′ in the transmissive region of FIG. 6.

FIG. 7D is a cross sectional view of an example boundary area between a transmissive region and a reflective region along a line D-D′ in the sub-pixel of FIG. 6.

FIG. 8 is a top view of an example sub-pixel of a transflective LCD having a barrier wall between the transmissive region and the reflective region.

FIG. 9A is a cross sectional view of an example sub-pixel of a transflective LCD along a line E-E′ in FIG. 8 showing a barrier wall that includes patterned green and blue layers.

FIG. 9B is a cross sectional view of an example sub-pixel of a transflective LCD along the line E-E′ in FIG. 8 showing a barrier wall that includes a patterned over coating layer.

FIG. 10 is a top view of an example sub-pixel structure of a transflective LCD.

FIG. 11A is a graph showing example simulated V-T and V-R curves of a transflective LCD.

FIG. 11B is a graph showing the V-T and V-R curves of FIG. 11A after normalization.

FIG. 11C is a graph showing example simulated 2D images having various brightness values generated by a transflective LCD.

FIG. 11D shows example simulated iso-contrast contour plots of the transmissive region of a transflective LCD.

FIG. 11E shows example simulated iso-contrast contour plots of the reflective region of a transflective LCD.

FIG. 12A shows example simulated liquid crystal orientations of a pixel in which a barrier wall is not used.

FIG. 12B shows a corresponding image shown by the pixel of FIG. 12A.

FIG. 12C shows example simulated liquid crystal orientations of a pixel in which a barrier wall is used.

FIG. 12D shows a corresponding image shown by the pixel of FIG. 12C.

FIG. 13A is a graph showing example simulated V-T and V-R curves of a transflective LCD.

FIG. 13B is a cross sectional diagram of an example transflective LCD whose simulated V-T and V-R curves are shown in FIG. 13A.

FIG. 13C is a graph showing example simulated V-T and V-R curves of a transflective LCD.

FIG. 13D is a cross sectional diagram of an example transflective LCD whose simulated V-T and V-R curves are shown in FIG. 13C.

FIG. 14A is a cross sectional view of an example transflective LCD.

FIGS. 14B and 14C show graphs of example relationships between simulated tilt and rotational angles and cell gaps at various positions of a transflective LCD under various configurations when the reflector electrode is between the common electrode and the liquid crystal layer.

FIGS. 14D and 14E show graphs of example relationships between simulated tilt and rotational angles and cell gaps at various positions of a transflective LCD under various configurations when the common electrode is between the reflector electrode and the liquid crystal layer.

### DETAILED DESCRIPTION

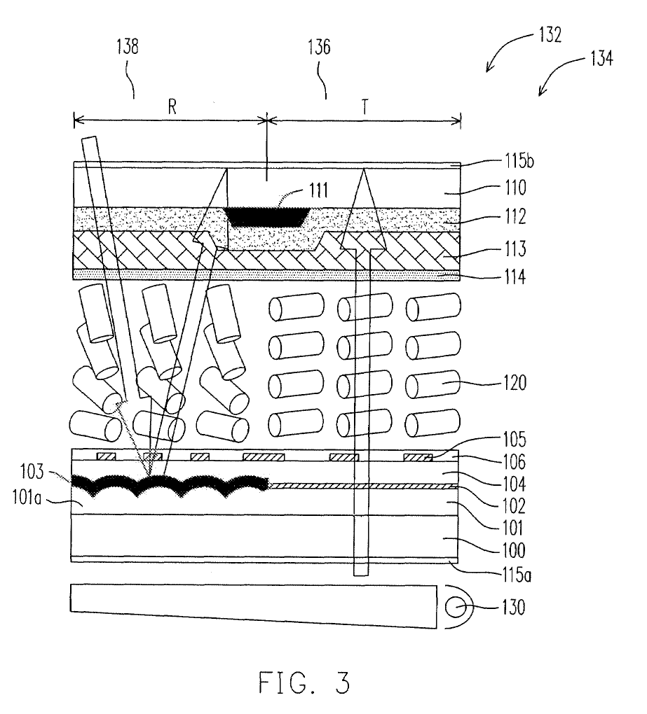

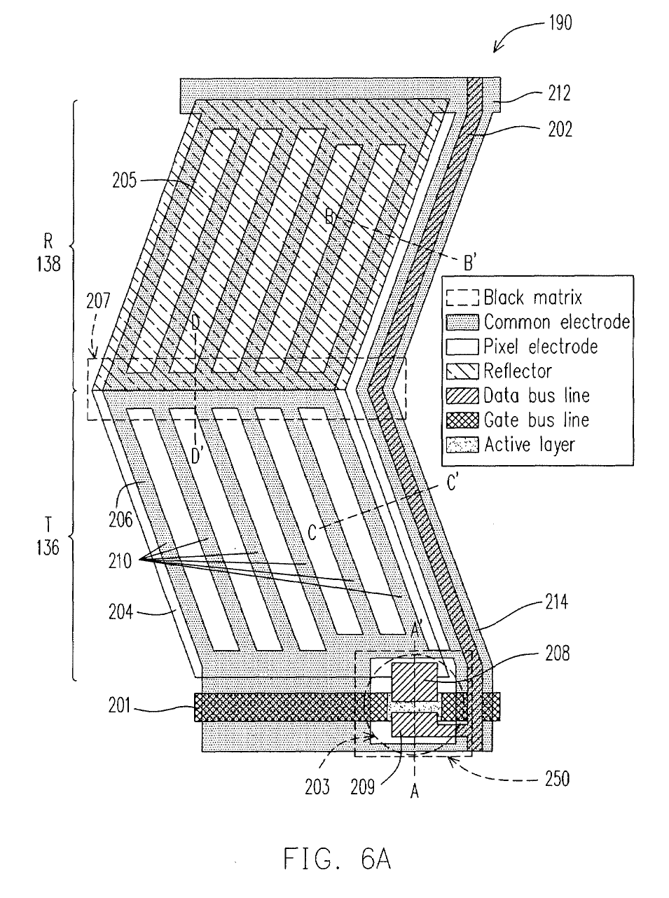

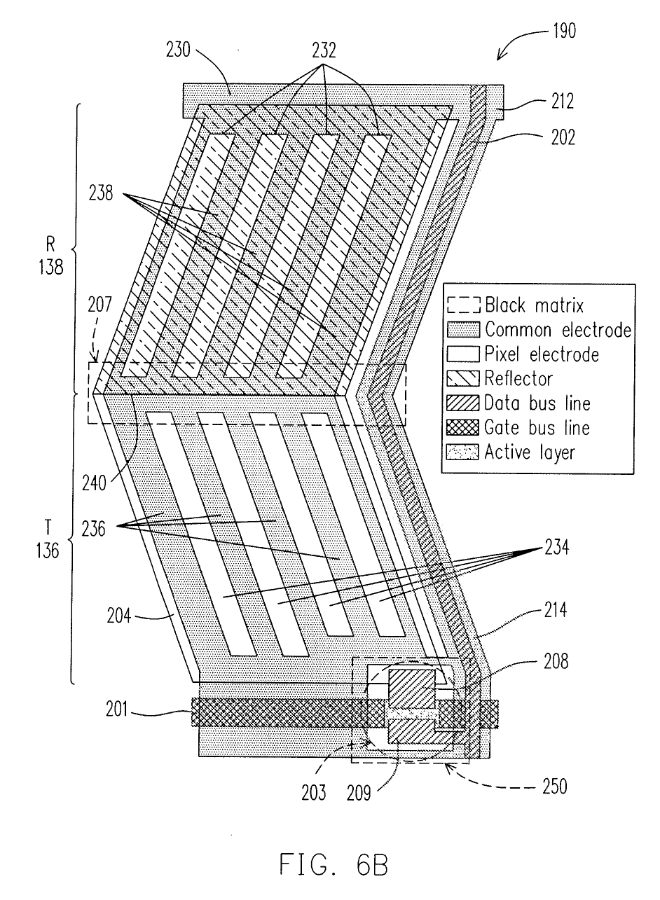

FIG. 3 is a cross-sectional view of an example pixel 132 of a single cell gap fringe field switching (FFS) based transflective liquid crystal display (TR-LCD) 134. The pixel 132 has a transmissive (T) region 136 and a reflective (R) region 138. In the example of FIG. 3, the pixel 132 is operating in a dark-state (e.g., the pixel 132 is driven to show a low luminance level). The pixel 132 uses a pixel-common inversion electrode structure in which a common electrode 105 is positioned between a liquid crystal layer 120 and a pixel electrode 102 and a reflector electrode 103. The common electrode 105 has elongated openings with stripes between the openings (see FIG. 6). Fringe fields generated by the common electrode 105, the pixel electrode 102, and the reflector electrode 103 switch the pixel 132 to various gray scale levels. A liquid crystal material having negative dielectric anisotropy is used. Upper and lower alignment layers are configured such that the liquid crystal layer in a transmissive region 136 has a homogenous alignment, whereas the liquid crystal layer in a reflective region 138 has a hybrid alignment. This allows the display 134 to achieve a wide viewing angle without using compensation films, use low pixel driving voltages to drive the pixel 132, and use a single gamma curve when operating in both the transmissive mode and the reflective mode.

The transmissive region and reflective region are sometimes referred to as transmissive sub-pixel and reflective sub-pixel, respectively.

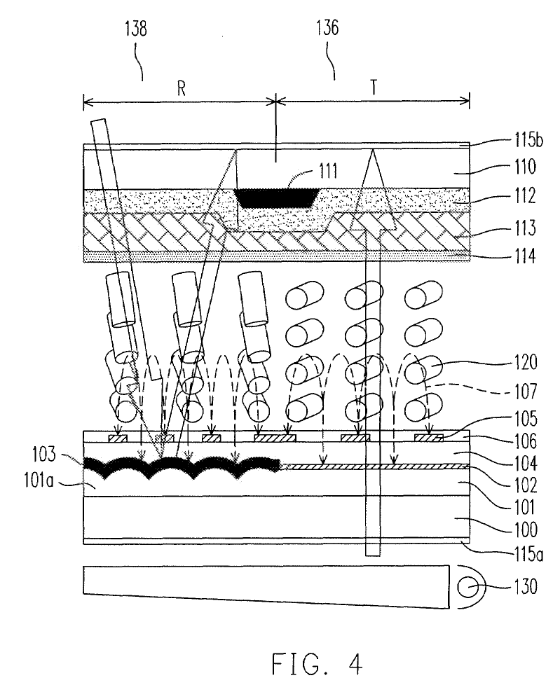

Although one pixel is shown in FIG. 3 (and FIGS. 4 and 6-10), it is understood that the display 134 includes a plurality of pixels (e.g., an array of rows and columns of pixels) that are used together to show images. The transflective LCD includes a backlight unit 130, a lower substrate 100 that is near the backlight unit 130, and an upper substrate 110 that is near a viewer. The liquid crystal layer 120 is between the two substrates 100 and 110, which in turn are between a bottom linear polarizer 115a and a top linear polarizer 115b.

In this description, a “pixel” refers to a unit that can be independently controlled to show a particular gray level. In some examples, three pixels having red, green, and blue colors (or other number of pixels and combination of colors) together form a color pixel, and each pixel is referred to as a “sub-pixel” of the color pixel.

A gate insulator layer 101 is formed on the lower substrate 100. In the R region 138, the gate insulator layer 101 is processed to have circular-shaped embossing patterns 101a, while the surface of the gate insulator layer 101 in the T region 136 remains smooth. In the R region 138, a reflector electrode 103 is formed on the gate insulator layer 101 with circular-shaped embossing patterns. This causes “bumps” to form on the surface of the reflector electrode 103 so that the reflector electrode 103 can scatter ambient light in various directions, resulting in more uniform luminance at various viewing angles. The reflector electrode 103 functions both as a reflector to reflect light and as an electrode to generate electric fields to control orientations of the liquid crystal molecules.

In the T region 136, a transparent pixel electrode 102 made of a transparent conductive material, such as indium tin oxide (ITO), is formed on the gate insulator layer 101. The pixel electrode 102 is electrically connected to the reflector electrode 103. A passivation layer 104 made of dielectric materials, such as SiOx and/or SiNx, is formed on the pixel electrode 102 and the reflector electrode 103.

A transparent common electrode 105 having many elongated branches or stripes is formed on the passivation layer 104, in which most of the stripes of the common electrode 105 overlap the pixel electrode 102 and the reflector electrode 103. In some examples, the common electrode 105 of all the pixels in the display 134 are electrically connected to have a common voltage. The width of the stripes and spacing between the stripes of the common electrode 105 in the T region 136 may be different from those in the R region 138, as described below.

A black matrix 111 is patterned on the inner surface of the upper substrate 110. A color filter layer 112 and an over coating layer 113 are formed on the inner surface of the upper substrate 110. A lower alignment layer 106 and an upper alignment layer 114 are printed on the inner surfaces of the lower substrate 100 and upper substrate 110, respectively.

The alignment layers 106 and 114 are treated differently in the T region 136 and the R region 138 so that the liquid crystal molecules in the T region 136 have a homogenous alignment, whereas the liquid crystal molecules in the R region 138 have a hybrid alignment.

In the transmissive region 136, the lower alignment layer 106 is treated (e.g., by photo-alignment method or by rubbing with mask) such that its alignment axis is at an angle of 2° to 5° with respect to the horizontal direction. The top alignment layer 114 is treated such that its alignment axis is aligned along an anti-parallel direction (i.e., parallel to but in opposite direction) with respect to the alignment direction of the lower alignment layer 106.

In this description, the terms “horizontal” and “vertical” are used to describe the orientations of various components of the display in the figures. Thus, for example, the surface of the substrates 100 and 110, and the surface of the alignment layers 106 and 114, are described and shown in the figures as being parallel to the horizontal direction. However, the display can be used in various orientations so that what we call horizontally or vertically aligned liquid crystal molecules may not be aligned along the horizontal or vertical direction using the earth as reference. Similarly, the terms “top,” “bottom,” “upper,” “lower,” “above,” and “below” are used to describe relative positions of components of the display in the figures. The display can have other orientations so that in some circumstances, for example, what we call a lower layer may be above what we call an upper layer.

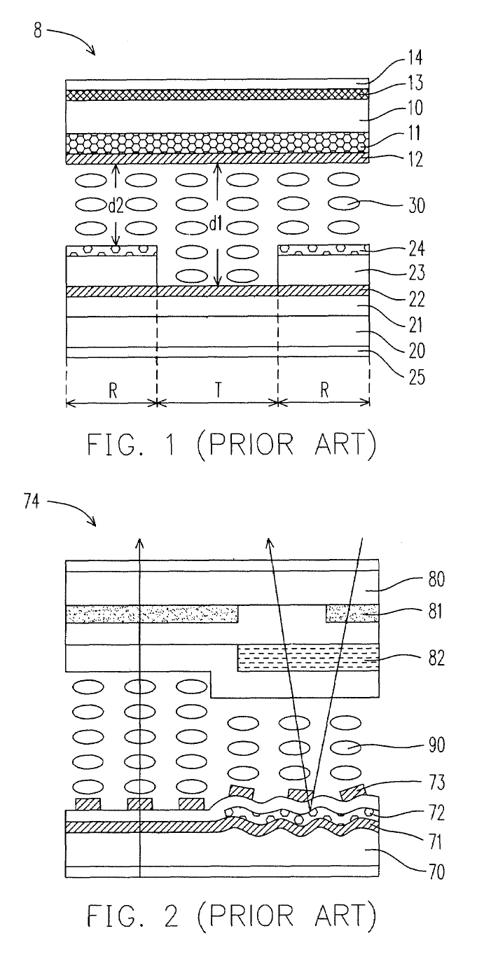

The cell gap in the transmissive region 136 is substantially the same as the cell gap in the reflective region 138. Because of manufacturing tolerances, the cell gap may not be entirely uniform across the entire transmissive and reflective regions. Some features of the pixel may cause the cell gap to be smaller or larger at some locations than others. Thus, when we say that a pixel has a single cell gap structure (or that the transmissive region 136 and the reflective region 138 have the same cell gap), it does not necessarily mean that the cell gap across the entire pixel is exactly the same. In this example, small differences in cell gaps, if any, are not meant to achieve a difference in optical phase retardation between the transmissive and reflective regions in order to compensate for the phase difference between the transmitted light (which passes the liquid crystal layer once) and the reflected light (which passes the liquid crystal layer twice), as is the case in the pixel structure of FIG. 1.

In the reflective region 138, the lower alignment layer 106 is treated (e.g., by photo-alignment or by rubbing with mask) such that its alignment axis is at an angle of about 45° (or −45°) with respect to the alignment axis of the lower alignment layer 106 in the transmissive region 136. The top alignment layer 114 in the R region 138 is treated (e.g., by photo-alignment or by printing a vertical alignment material with mask) such that the liquid crystal molecules near the top alignment layer 114 in the R region 138 have a vertical tilt angle (i.e., the liquid crystal molecules are aligned along the vertical direction).

In some examples, the different surface alignment directions of the transmissive and reflective regions can be achieved by the following process. First, on the bottom array substrate, the transmissive portion of the lower alignment layer 106 is photo-aligned to have a predetermined alignment angle by using a photo-mask that exposes the transmissive portion of the lower alignment layer 106 and covers the reflective portion of the alignment layer 106. This way, the reflection portion of the lower alignment layer 106 is shielded by the photo mask and is not exposed to the irradiation UV light or ion beam used for the photo-alignment. Another photo-mask that has an opening that exposes the reflective portion of the lower alignment layer 106 and covers the transmissive portion of the alignment layer 106 is used to photo-align the reflective portion of the alignment layer 106 at a different angle. A similar process can be used to process the upper alignment layer 114 such that the transmissive and reflective portions of the upper alignment layer 114 have different alignment angles.

In some examples, the different surface alignment directions of the transmissive and reflective regions can be achieved by the following process. First, on the bottom array substrate 100, a portion of the lower alignment layer 106 in the transmissive region is rubbed (e.g., by a roller) to have a predetermined alignment direction by using a mask that exposes the portion of the alignment layer 106 in the transmissive region and covers the portion of the alignment layer 106 in the reflective region. This way, the portion of the lower alignment layer 106 in the reflective region is shielded by the mask and is not exposed to the roller. Another mask that has an opening that exposes the portion of the lower alignment layer 106 in the reflective region and covers the portion of the alignment layer 106 in the transmissive region is used when rubbing the portion of the alignment layer 106 in the reflective region at a different alignment direction.

On the upper substrate 110, the upper alignment layer 114 is rubbed along an anti-parallel direction (i.e., parallel to but in opposite direction) with respect to the alignment direction of the lower alignment layer 106 in the transmissive region 136. A mask that has an opening that exposes the portion of the upper alignment layer 114 in the reflective region and covers the portion of the alignment layer 114 in the transmissive region is used when printing the portion of the alignment layer 114 in the reflective region with a vertical alignment material.

In some examples, the transflective LCD 134 uses a negative dielectric liquid crystal material 120 that has a dielectric anisotropy (Δε) of −4.0. In this display, a homogeneous alignment is used for the transmissive region 136 and a hybrid alignment configuration is used in the reflective region 138. This allows a good dark state to be achieved in the reflective region 138 without using an in-cell retarder.

To reduce the driving voltage, a pixel common inversion (PCI) electrode structure is used, in which the common electrode 105 is positioned between the pixel electrode 102 (or the reflector electrode 103) and the liquid crystal layer 120. This configuration allows the pixel electrode 102 and the reflector electrode 103 to be driven with a lower driving voltage, as compared to placing the pixel electrode 102 between the common electrode 105 and the liquid crystal layer 120.

Each pixel 132 of the transflective FFS LCD 134 is normally dark when no pixel voltage (also referred to as pixel driving voltage) is applied to the pixel electrode 102 and reflector electrode 103, or when a pixel voltage corresponding to the lowest luminance level is applied to the electrodes 102 and 103. To achieve minimum light leakage in the reflective region 138, the top linear polarizer 115b has its transmission axis aligned at about 45° (or −45°) with respect to the alignment direction of the bottom alignment layer 106 in the reflective region 138. In the dark state, ambient (or external) light passes the top polarizer 115b to form linearly polarized light.

The liquid crystal material and the thickness of the liquid crystal layer 120 (i.e., the cell gap) are selected so that a phase retardation of λ/4 (at, e.g., λ=550 nm) is imparted between two perpendicular polarization components of light that passes the liquid crystal layer 120 in the reflective region 136. For the light having a wavelength λ=550 nm, the liquid crystal layer 120 functions similar to a quarter wave plate. Linearly polarized light becomes circularly polarized light after passing the liquid crystal layer 120. After the light is reflected by the reflector electrode 103, the light propagates through the liquid crystal layer 120 again and becomes linearly polarized light that is rotated to a direction 90° relative to the transmission axis of the top polarizer 115b. This causes the light to be blocked by the top polarizer 115b, achieving a good dark state.

In the transmissive region 136, in the dark state, light generated by the backlight unit 130 passes the bottom polarizer 115a to form linearly polarized light. The alignment layers 106 and 114 in the transmission region 136 are processed such that the alignment axes of the lower alignment layer 106 and the upper alignment layer 114 are the same, and are either parallel to the transmission axis of the lower polarizer 115a or the transmission axis of the upper polarizer 115b. This way, the liquid crystal molecules are aligned parallel to the transmission axis of the bottom polarizer 115a or top linear polarizer 115b, so the light passes through the liquid crystal layer 120 without change of polarization state. The light is blocked by the top polarizer 115b, resulting in a dark state, similar to that of the reflective mode.

FIG. 4 is a cross-sectional view of the pixel 132 of the single cell gap FFS based transflective LCD 134 in a bright-state (e.g., when the pixel 132 is driven to show a high luminance level). To achieve a maximum transmittance in the transmissive region 136, the configuration of the common electrode 105 in the transmissive region 136 (e.g., the width of stripes and spacing of stripes of the common electrode 105) and a driving voltage Vmax corresponding to the maximum luminance level are selected such that a phase retardation of λ/2 (at λ=550 nm) is imparted between two perpendicular polarization components of light passing the liquid crystal layer 120 in the transmissive region 136 when Vₘₐₓ is applied between the electrodes 102 and 105.

When a driving voltage Vmax is applied between the electrodes 105 and 102, fringe fields 107 generated by the electrodes 105 and 102 cause liquid crystal directors to rotate about 45°. When the linearly polarized backlight from the bottom polarizer 115a propagates through the liquid crystal layer 120, its polarization direction rotates 90° to allow the backlight to pass the top polarizer 115b, resulting in a bright state.

In the reflective region 138, when Vₘₐₓ is applied between the electrodes 105 and 103, fringe fields generated by the electrodes 105 and 103 rotate the bottom liquid crystal directors about 45° (the liquid crystal molecules near the bottom substrate are rotated 45°, but the liquid crystal molecules near the upper substrate remain substantially vertical). This causes the bottom liquid crystal directors to be either parallel or perpendicular to the polarization direction of the upper polarizer.

If the bottom liquid crystal molecules are parallel to the polarization direction of the upper polarizer, ambient light does not change polarization when it passes the liquid crystal layer, so the reflected light pass the upper polarizer, resulting in a bright state. If the bottom liquid crystal molecules are perpendicular to the polarization direction of the upper polarizer, when linearly polarized ambient light passes the liquid crystal layer 120 once, the polarization direction of the light is still not rotated and will then be reflected by the reflector. When the light passes the liquid crystal layer 120 a second time, the polarization direction of the light is maintained to allow the reflected ambient light to pass the top polarizer 115b, resulting in a bright state.

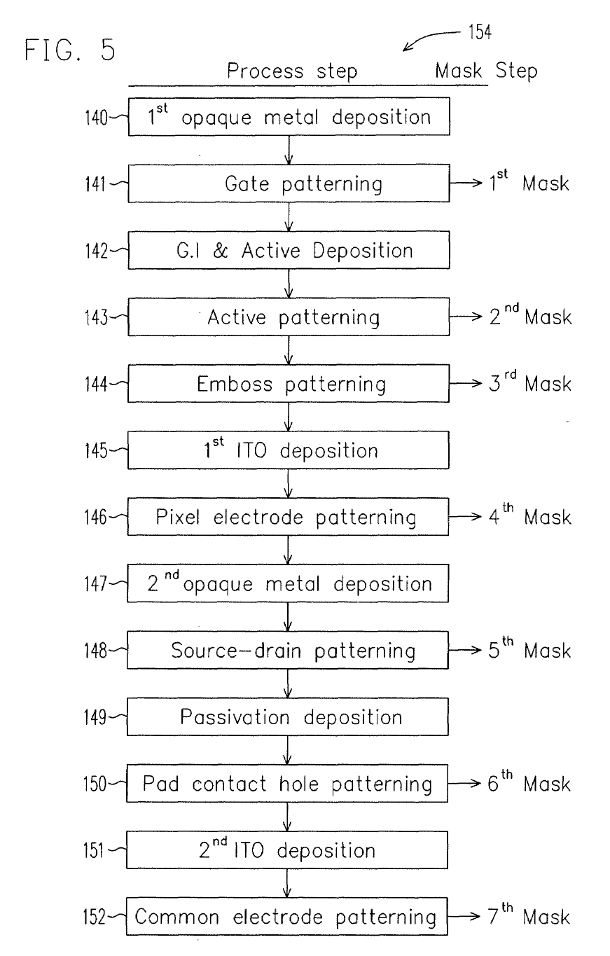

FIG. 5 is a flow diagram of an example process 154 for fabricating the transflective high-brightness FFS-LCD 134. A first opaque metal layer is deposited (step 140) on the lower glass substrate 100. A gate patterning step is performed (step 141), in which a gate bus line including a gate electrode and gate pads are formed by etching the first opaque metal layer using a first photo mask. The first opaque metal layer can be, for example, MoW, an alloy Al—Nd, or a stacked layer of Mo/Al. Each layer can be deposited using a sputtering process. When the first opaque metal layer is a MoW layer, etching of the MoW layer can be performed by dry etching method using SF₆ gas or CF₄ and O₂ gases. When the first opaque metal layer is an Al—Nd alloy layer or a Mo/Al stacked layer, etching of the layers can be performed by wet etching method using an etchant including a mixture of H₃PO₄, CH₃COOH, HNO₃, and H₂O.

A gate insulator layer and active area deposition is performed (step 142), in which a SiON layer, an amorphous silicon (a-Si) layer, and an n+ a-Si layer are successively deposited by a plasma enhanced chemical vapor deposition (PECVD) method. The active region of the thin film transistor (TFT) is patterned by etching the n+ a-Si layer and a-Si layer using a second photo mask (step 143). The etching of the active layers can be performed by dry etching method using SF₆, He and HCl gases. The SiON layer functions as a gate insulator layer (e.g., 101).

An embossing pattern (which when coated with a reflective layer provides a scattering effect with respect to incident light) is formed by coating a photo sensitive organic (PSO) layer or a photo resistor (PR) layer, exposing the PSO or PR layer to UV light using a third photo mask, and developing the PSO or PR layer with a developing etchant (step 144). A transparent conductive layer, for example, an indium tin oxide (ITO) layer, is deposited by a sputtering method using, e.g., Ar gas, O₂ gas and ITO target (step 145).

Patterning of the pixel electrode (e.g., 102) is performed by etching the ITO layer using a fourth mask (step 146). The ITO layer is etched by a wet etching method using HCl, HNO₃ and H₂O as etchant. A second opaque metal layer is deposited by a sputtering process (step 147). Source-drain electrodes, reflective pixel electrodes and the data bus line including data pads are patterned by etching the second opaque metal layer using a fifth mask (step 148). The drain electrode is electrically connected to the pixel electrode (e.g., 102). The second opaque metal layer can be made of, e.g., MoW, an alloy Al—Nd, or a stacked layer of Mo/Al, which can be formed by sputtering each target material. When the second opaque metal layer is a MoW layer, the MoW layer can be etched by a dry etching method using SF₆ gas or CF₄ and O₂ gases. When the second opaque metal layer is an Al—Nd alloy layer or a Mo/Al stacked layer, the layers can be etched by a wet etching method using an etchant that includes a mixture of H₃PO₄, CH₃COOH, HNO₃, and H₂O.

A passivation layer of SiNx is deposited (step 149) using PECVD over the resultants of previous processing steps, followed by patterning portions of the gate pads and data pads by etching the passivation layer (e.g., 104) formed on the pad using a sixth mask (step 150). Etching the passivation layer can be performed by a dry etching method using SF₆ gas or O₂ gas. A second transparent metal layer, e.g., an ITO layer, is deposited on the passivation layer using a sputtering method (step 151). A common electrode (e.g., 105) having a chevron shape with many stripes and a matrix of common bus lines are patterned by etching the ITO layer using a seventh mask (step 152). The common electrode is formed to overlap the pixel electrode with a passivation layer between the common electrode and the pixel electrode.

FIG. 6A is a top view of an example pixel 190 of a transflective high-brightness FFS-LCD. An opaque gate bus line 201 extends along a row direction, and an opaque data bus line 202 extends along a column direction. The opaque gate bus line 201 and data bus line 202 can be made of metals such as MoW, alloy Al—Nd, or a stacked layer of Mo/Al, and can be formed by using a sputtering process. In some examples, the gate bus line 201 and the data bus line 202 each has a thickness of about 200˜350 nm. The data bus line 202 has a chevron shape that conforms with the chevron shape of the pixel electrode 204 and the common electrode 206. A gate insulator layer (not shown in the figure) is deposited on the gate bus line, in which the gate insulator layer can be made of SiON and can have a thickness of 400 nm.

A thin film transistor (TFT) 203 is disposed near an intersection of the gate bus line 201 and the data bus line 202. The TFT 203 includes a source electrode 208 and a drain electrode 209. The TFT 203 functions as a switch to turn on or off driving of the pixel. In the reflective region 138, in order to provide a scattering effect with respect to incident light, the gate insulator layer is patterned to have circle shape embossing patterns.

In the transmissive region 136, a planar pixel electrode 204 is formed on the gate insulator layer. The pixel electrode 204 can be made of a transparent metal layer, such as indium-tin-oxide (ITO), and can have a thickness of about 40 nm. In the reflective region 138, a reflective pixel electrode 205 is formed on the gate insulator layer. One side of the pixel electrode 204 is connected with the source electrode 208 to receive a pixel data voltage from the data bus line 202 when the TFT 203 is turned on.

A chevron shape common electrode 206 having many stripes 210 and a matrix shape common bus line 212 are formed on the passivation layer. Many stripes 210 of the common electrode 206 overlap the pixel electrode 204 in the vertical direction (but electrically insulated from each other) and one stripe 214 of the common electrode 206 overlaps the data bus line 202 in the vertical direction (but electrically insulated from each other). The vertical direction refers to the direction perpendicular to the surfaces of the substrates 100 and 110. The common electrode 206 has an opening in an area where the TFT 203 is located. A black matrix 250 (shown in dashed lines) formed on the inner surface of the upper substrate 110 covers the TFT 203 and the boundary between the transmissive region 136 and the reflective region 138.

The openings in the common electrode can have various shapes. For example, FIG. 6B is a top view of an example common electrode 230 that defines openings 232 in the reflective region 138 and openings 234 in the transmissive region 136. The openings 232 and 234 are at alternating positions such that each opening 232 in the R region 138 corresponds to a stripe 236 of the common electrode in the T region 136, and each opening 234 in the T region 136 corresponds to a stripe 238 of the common electrode in the R region 138. The common electrode 230 has an overall chevron geometry with openings 232 and 234 that are not symmetrical with respect to a border 240 between the transmissive and reflective regions.

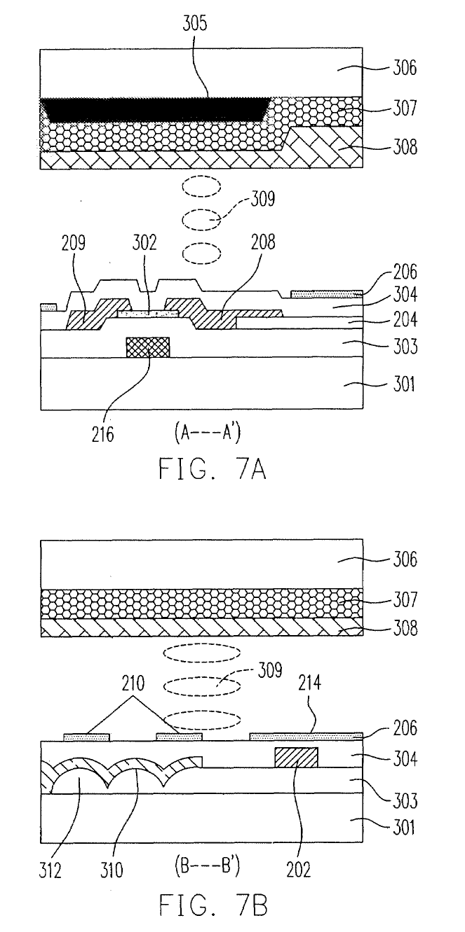

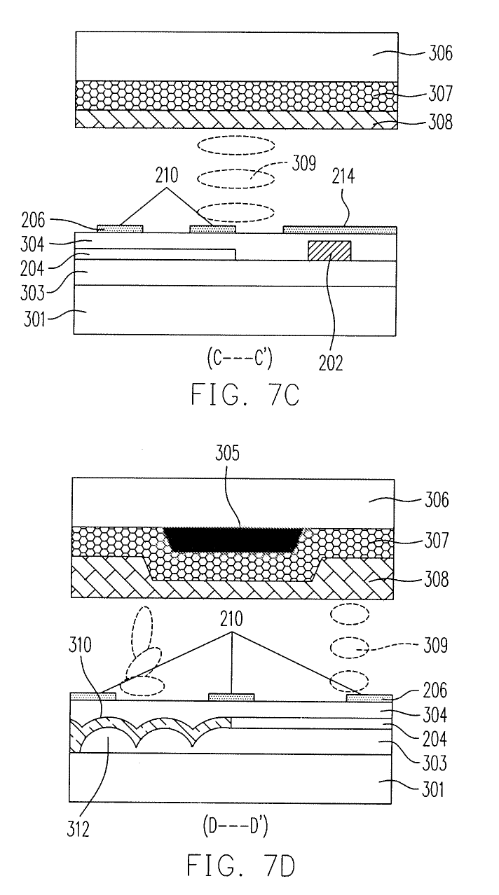

FIG. 7A is a cross sectional view of an example TFT area along a line A-A′ in the pixel of FIG. 6A. A gate electrode 216 is formed on a lower substrate 301. After deposition of three layers (i.e., a gate insulator 303, an a-Si 302, and a n+ a-Si), the active layers (a-Si and n+ a-Si) that overlap the gate electrode 216 are patterned and formed on the gate insulator layer 303. A planar pixel electrode 204 is formed on the gate insulator layer 303. After deposition of an opaque metal layer, a source electrode 208 and a drain electrode 209 are formed. The source electrode 208 is connected to the pixel electrode 204.

A passivation layer 304 is formed above the source electrode 208 and drain electrode 209. A common electrode 206 having many stripes is formed on the passivation layer 304. Many stripes of the common electrode 206 overlap the pixel electrode 204, in which the passivation layer 304 insulates the common electrode 206 from the pixel electrode 204.

A black matrix 305 that includes resin with carbon particles, a double layer of chrome and chrome oxide, or a chrome-oxidized layer, is formed on an upper substrate 306. A color filter resin layer 307 is coated on the black matrix 305. An over coat layer 308 is coated on the color filter resin layer 307.

A lower alignment layer and an upper alignment layer (not shown in the figure) are printed on the inner surfaces of the lower substrate 301 and the upper substrate 306, respectively. The lower substrate 301 having arrayed electrodes and the upper substrate 306 having the black matrix 305 and red-green-blue color filter patterns are disposed opposite to each other and spaced apart at a predetermined cell gap. Lower and upper polarizers (not shown in the figure) are attached to the outer surfaces of the lower 301 and upper 306 substrates, respectively.

Liquid crystal molecules 309 having a negative dielectric anisotropy are disposed between the substrates 301 and 306. In the transmissive region (e.g., 136 of FIG. 6A), the lower polarizer has a transmission axis parallel to an alignment axis of the lower alignment layer, and the upper polarizer has a transmission axis perpendicular to that of the lower polarizer.

FIG. 7B is a cross sectional view of an example data bus line area along a line B-B′ in the reflective region 138 of the pixel of FIG. 6A. A gate insulator layer 303 having embossing patterns 312 is formed on the lower substrate 301. A reflector layer 310, which is connected to a pixel electrode (not shown in the figure) in the transmissive region 136, and a data bus line 202 are formed on the gate insulator layer 303.

A passivation layer 304 is deposited above the reflector layer 310 and the data bus line 202. A common electrode 206 having several stripes is formed and patterned on the passivation layer 304. Many of the stripes of the common electrode 206 overlap the reflector 310. One stripe 214 of the common electrode 206 overlaps the data bus line 202, in which the stripe 214 and the data bus line 202 are electrically insulated from each other. An electric field generated by the data bus line 202 is shielded by the stripe 214 of the common electrode 206.

A color pigment layer 307 and an over coating layer 308 are coated on the upper substrate 306. A lower alignment layer and an upper alignment layer (not shown in the figure) are printed on the inner surfaces of the lower substrate 301 and upper substrate 306, respectively. A liquid crystal mixture 309 having a negative dielectric anisotropy is injected into the space between the upper and lower alignment layers.

FIG. 7C is a cross sectional view of an example data bus line area along a line C-C′ in the transmissive region 136 of the pixel of FIG. 6A. A planar pixel electrode 204 and a data bus line 202 are formed on a gate insulator layer 303. A passivation layer 304 is deposited above the pixel electrode 204 and the data bus line 202. A common electrode 206 having many stripes 210 is formed and patterned on the passivation layer 304. Many of the stripes 210 of the common electrode 206 overlap the pixel electrode 204. One stripe 214 of the common electrode 206 covers the data bus line 202, so an electric field generated by the data bus line 202 is shielded by the stripe 214.

A color pigment layer 307 and an over coating layer 308 are coated on the upper substrate 306. A lower alignment layer and an upper alignment layer (not shown in the figure) are printed on the inner surfaces of the lower substrate 301 and upper substrate 306, respectively. A liquid crystal mixture 309 having negative dielectric anisotropy is injected into the space between the upper and lower alignment layers.

FIG. 7D is a cross sectional view of an example boundary area 207 between the transmissive region 136 and the reflective region along a line D-D′ in the pixel of FIG. 6A. The gate insulator layer 303 having embossing patterns 312 is formed patterned on the lower substrate 301. The reflector layer 310 of the reflective region 138 and the transparent pixel electrode 204 are formed on the gate insulator layer 303. The reflector layer 310 and the pixel electrode 204 are electrically connected.

A passivation layer 304 is deposited above the reflector layer 310 and the pixel electrode 204. A common electrode 206 having many stripes 210 is formed and patterned on the passivation layer 304. Many of the stripes 210 of the common electrode 206 overlap the reflector electrode 310 and the pixel electrode 204.

A black matrix 305 is formed on the upper substrate 306. A color pigment layer 307 and an over coating layer 308 are coated on the black matrix layer 305. A lower alignment layer and an upper alignment layer (not shown in the figure) are printed on the inner surfaces of the lower substrate 301 and the upper substrate 306, respectively. In the transmissive region 136, the lower alignment layer is treated such that its alignment axis is aligned along the horizontal direction, and the top alignment layer is such that its alignment axis is parallel to but in the opposite direction with respect to the alignment direction of the lower alignment.

In the reflective region 138, the lower alignment layer is photo-aligned such that its alignment axis is +45° or −45° with respect to the alignment axis of the lower alignment layer in the transmissive region 136. The top alignment layer in the reflective region 138 is treated to have an alignment direction that is perpendicular to the top substrate surface.

The different surface alignment directions of the transmissive and reflective regions can be achieved by the following process. The lower alignment layer in the transmissive region 136 is photo-aligned by using a photo mask that is open only to the transmissive region 136 (so that in the reflective region 138, the irradiation UV light or ion beam used for the photo-alignment process is shielded by the photo mask). The lower alignment layer in the reflective region 138 is photo-aligned by using another photo mask that is open only to the reflective region 138, and the lower alignment layer in the reflective region 138 is photo-aligned to have an alignment direction that is different from the lower alignment layer in the transmissive region 136. A similar process can be used to treat the upper alignment layer in the transmissive region 136 and the reflective region 138. A liquid crystal mixture 309 having negative dielectric anisotropy is injected into the space between the upper and lower alignment layers.

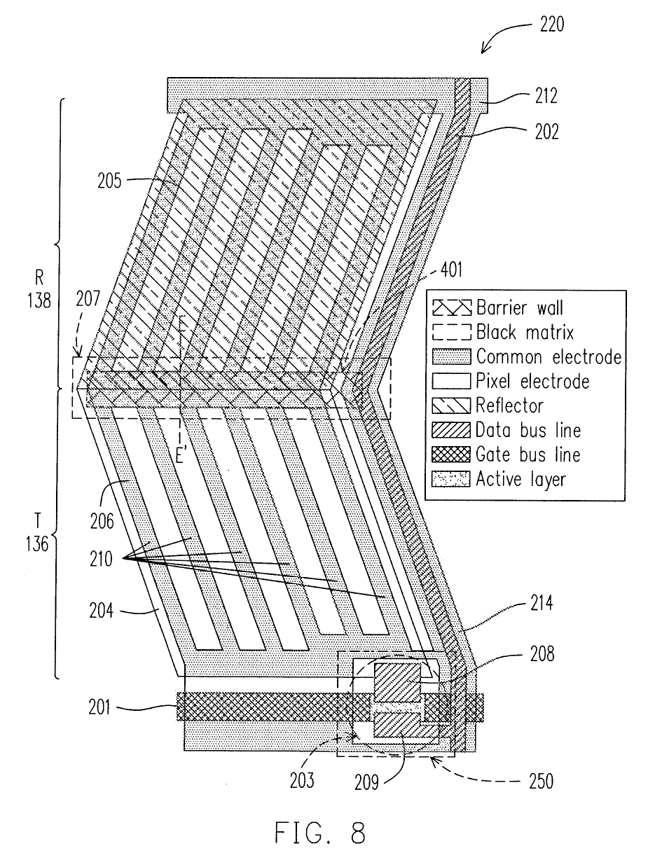

FIG. 8 is a top view of an example pixel 220 of a transflective high-brightness FFS-LCD that is similar to the pixel structure 190 of FIG. 6A except that the pixel structure 220 has a barrier wall 401 at a boundary between the transmissive region 136 and the reflective region 138. The barrier wall 401 is formed on the black matrix 250 to control light leakage in the transmissive region 136 in the black state.

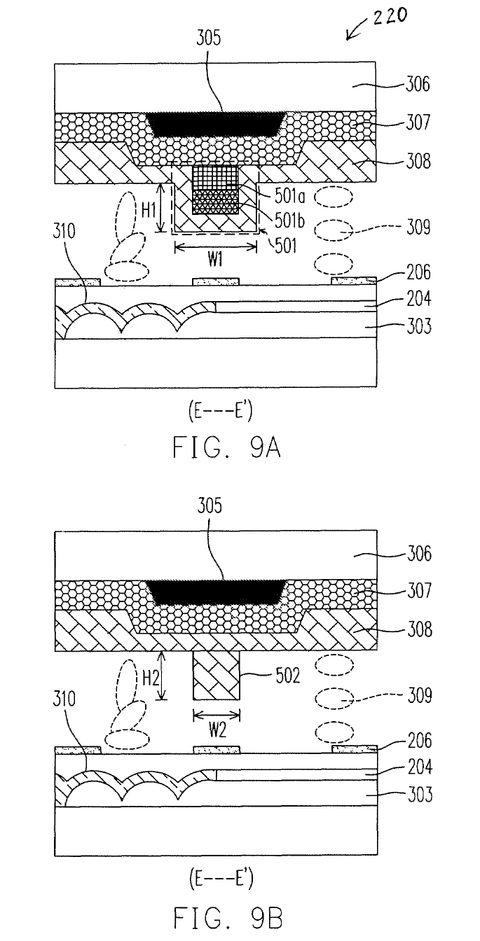

FIG. 9A is a cross sectional view of an example boundary area along a line E-E′ in the pixel 220 of FIG. 8, in which patterned green and blue pigment layers are used as barrier wall layers. In the example of FIG. 9A, the pixel 220 includes a red pigment layer 307. The structure in FIG. 9A is similar to that in FIG. 7D, except that the pixel 220 has a barrier wall 501 that includes a patterned green barrier wall layer 501a and a blue barrier wall layer 501b. The gate insulator layer 303, reflector layer 310, pixel electrode 204, common electrode 206, black matrix 305, color pigment layer 307, over coating layer 308, upper and lower alignment layers, and liquid crystal mixture 309 are the same for FIGS. 7D and 9A.

The green barrier wall layer 501a and the blue barrier wall layer 501b are deposited and patterned at the same time that the green pigment layer and the blue pigment layer are deposited and patterned to form green and blue filters for the green and blue pixels, respectively. In the example shown in FIG. 9A, the pixel is a red pixel. A red pigment layer 307 covering the whole pixel region (both transmissive and reflective regions) is formed on the upper substrate 306. When a green pigment layer for a green pixel is being patterned, the green barrier wall layer 501a having a bar shape extending along the boundary between the transmissive region 136 and the reflective region 138 remains on the red pigment layer 307. When a blue pigment layer for a blue pixel is being patterned, the blue barrier wall layer 501b having a bar shape remains on the green barrier wall layer 501a. An over coating layer 308 is coated over the whole area. Also, the patterned barrier wall layer 501 can function as a spacer to maintain the cell gap of the liquid crystal display. In some examples, the patterned barrier wall layer 501 has a height (H1) of about 0.4˜3.2 μm and a width (W1) of about 3˜20 μm.

FIG. 9B is a cross sectional view of an example boundary area along a line E-E′ in the pixel 220 of FIG. 8, in which a patterned over coating layer 502 is used as a barrier wall layer. The gate insulator layer 303, reflector layer 310, pixel electrode 204, common electrode 206, black matrix 305, color pigment layer 307, over coating layer 308, upper and lower alignment layers, and liquid crystal mixtures 309 are the same for FIGS. 9A and 9B. The difference between the pixels of FIGS. 9A and 9B is that the pixel of FIG. 9A uses green and blue pigment layers to form a barrier wall layer, whereas the pixel of FIG. 9B uses a patterned over coating layer 502 to from a barrier wall layer. In the example of FIG. 9B, an additional over coating layer 502 is used as a barrier wall layer. Also, the patterned barrier wall layer 502 can act as a spacer to maintain the cell gap of the liquid crystal display. In some examples, the over coating barrier wall layer 502 has a height (H2) of about 0.4˜3.2 μm and a width (W2) of about 3˜20 μm.

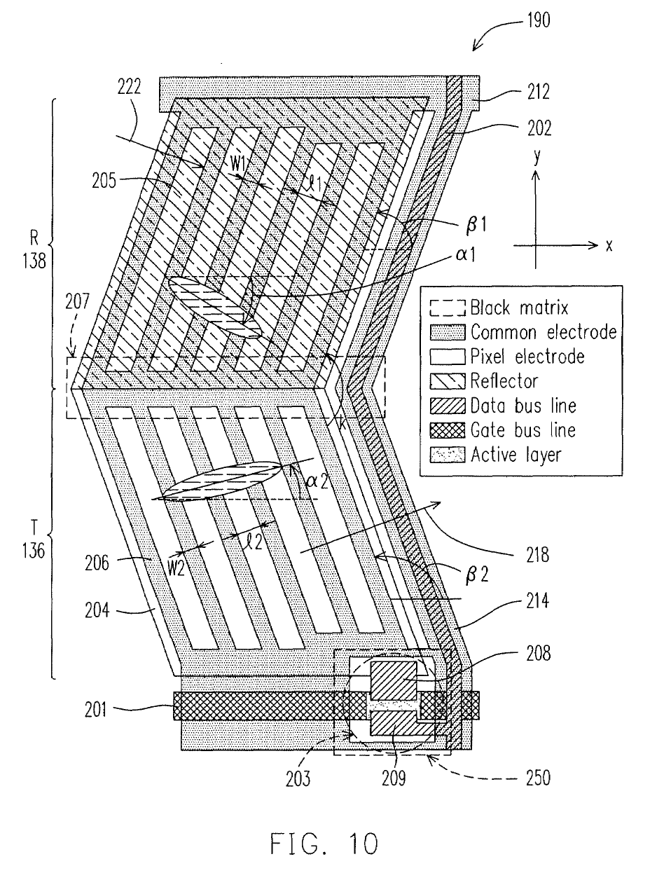

FIG. 10 shows examples of orientations of liquid crystal molecules and dimensions of the pixel structure of the transflective pixel 190 of FIG. 6A. In the reflective region 138, the stripes of the common electrode 206 extend in a direction at an angle β1=60 to 80° with respect to the gate bus line 201 (which extends in the row direction). In the transmissive region 136, the stripes of the common electrode 206 extend in a direction at an angle β2=100 to 120° with respect to the gate bus line 201.

In some examples, in the reflective region 138, the stripes of the common electrode 206 each has a width w1 (referred to as electrode width) of about 1 to 3 μm, and the spacing l1 (referred to as electrode spacing) between the stripes of the common electrode 206 is about 2 to 4 μm. In the transmissive region 136, the stripes of the common electrode 206 each has width w2 of about 2 to 4 μm, and the spacing l2 between the stripes of the common electrode 206 is about 4 to 6 μm. The electrode widths (w1 and w2) and electrode spacing (l1 and l2) are designed to achieve high light efficiency and a good matching between voltage-transmittance (V-T) and voltage-reflectance (V-R) curves.

Upper and lower alignment layers (not shown in the figure) are coated on the glass substrates. In the transmissive region 136, the lower alignment layer is treated such that its alignment axis α2 is at an angle of about 3 to 23° with respect to the x-direction (which is parallel to the row direction). The top alignment layer is treated such that its alignment axis is parallel to but in opposite direction with respect to the alignment direction of the lower alignment layer.

In the reflective region 138, the lower alignment layer is photo-aligned such that its alignment axis α1 is at an angle about +45° or −45° with respect to the alignment axis of the lower alignment layer in the transmissive region 136, i.e., α1=α2±45°. The top alignment layer in the reflective region 138 is treated such that it has a vertical tilt angle.

The common electrode stripes in the transmissive region 136 and the common electrode stripes in the reflective region 138 form a chevron shape having an angle (κ) about 120° to 160° from each other. In the transmissive region 136, the bottom alignment layer has an angle about 12° with respect to a direction 218 that is perpendicular to the common electrode stripes in the transmissive region 136. In the reflective region 138, the bottom alignment layer also has an angle about 12° with respect to a direction 222 that is perpendicular to the common electrode stripes in the reflective region 138. Such alignment directions are useful when a negative dielectric anisotropic liquid crystal is used.

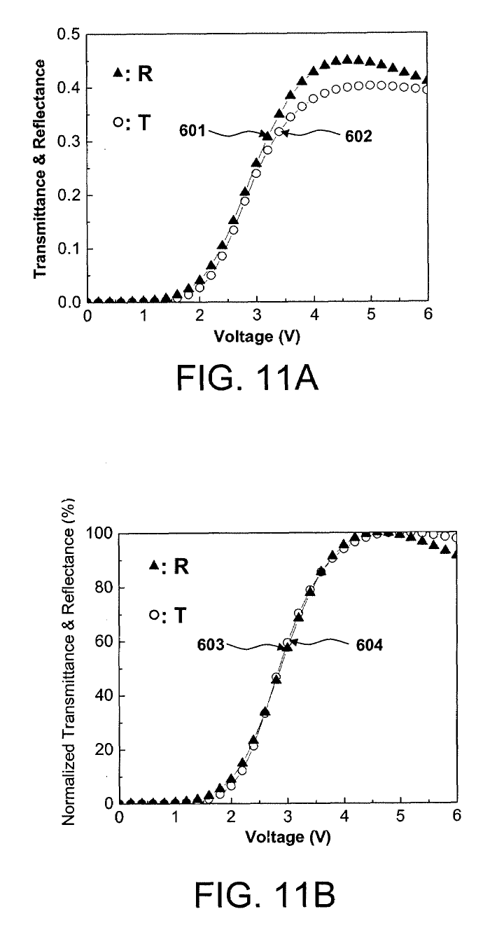

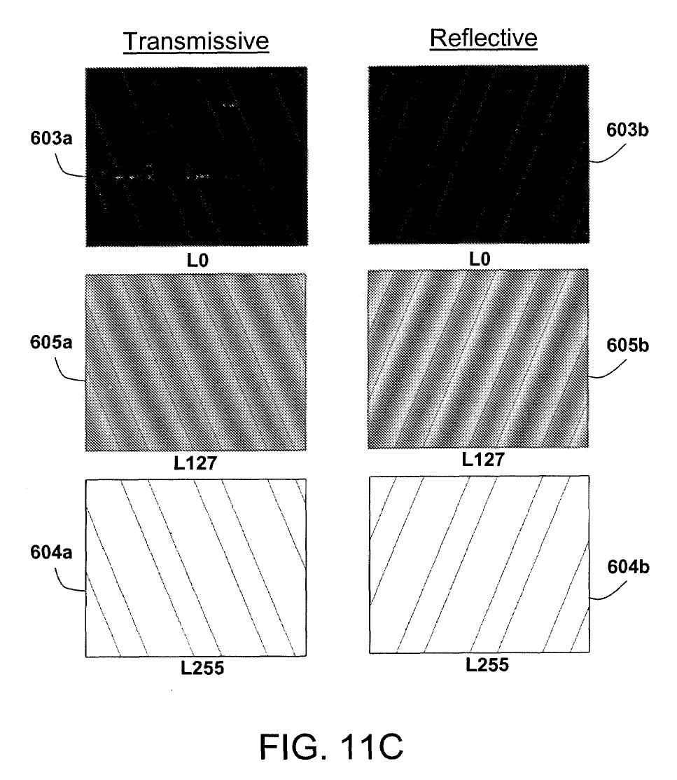

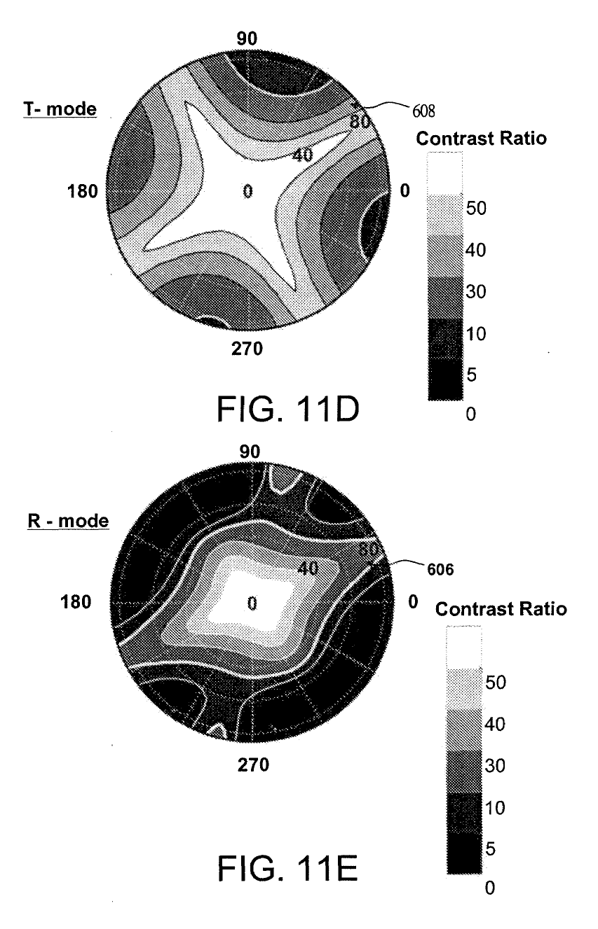

FIG. 11A shows examples of simulated V-R curve 601 and V-T curve 602 of the transflective pixel 190 of FIG. 10. The horizontal axis represents the pixel data voltage. The voltage used in this description refers to the root-mean-square voltage. In this example, the transmissive region 136 and the reflective region 138 have the same cell gap of about 3.77 μm. In the transmissive region 136, the electrode width w2 is equal to 3 μm and the electrode spacing l2 is equal to 5 μm. In the reflective region 138, the electrode width w1 is equal to 2 μm and the electrode spacing l1 is equal to 3 μm. The liquid crystal material used is MJ98468 from Merck, which has the following physical properties: extraordinary refractive index ne=1.5512 (at λ=589 nm), ordinary refractive index no=1.4742 (at λ=589 nm), dielectric anisotropy Δε=−4.0, rotational viscosity γ1=136 mPa·s, and elastic constants K11=13.5 pN, K22=7 pN and K33=15.1 pN.

Under the conditions described above, in the transmissive region 136, Vth˜2.1 Vrms, Von ˜5.0 Vrms, and Tmax ˜80% (normalized to the maximum transmittance of two parallel linear polarizers), where Vth is the threshold voltage, and Von is the driving voltage. In this example, the maximum transmittance of two parallel linear polarizers is about 0.5. In the reflective region 138, we find Vth˜2.0 Vrms, Von ˜4.6 Vrms, and Rmax ˜90% (normalized to the maximum reflectance of light after passing the one linear polarizer twice). Here, the maximum reflectance of light after passing the upper linear polarizer twice is about 0.5. When Tmax is about 80% and Rmax is about 90%, this means that the maximum value of transmittance or reflectance is about 0.4 or 0.45, as compared to the maximum value of 0.5.

FIG. 11B shows a normalized reflectance curve 603 and a normalized transmittance curve 604. The curves 603 and 604 match each other well for data voltages 0 to 5V. There is an almost perfect grayscale match between operating the display in the transmissive and reflective modes. This allows the driving of both transmissive and reflective modes using a single gamma curve.

FIG. 11C shows example simulated 2-dimensional brightness images shown by the pixel 190 of FIG. 10. The parameters of the pixel 190 are the same as those used in the simulations for FIG. 11A. In this example, the pixel 190 is configured to have 256 gray levels between its full bright state (represented by L255 gray level) and full dark state (represented by L0 gray level). When a pixel voltage that corresponds to the L0 gray level is applied to the pixel 190, the transmissive and reflective regions 136 and 138 show dark images 603a and 603b, respectively. When a pixel voltage that corresponds to L127 gray level is applied to the pixel 190, the transmissive and reflective regions 136 and 138 show gray images 605a and 605b, respectively. When a pixel voltage that corresponds to the L255 gray level is applied to the pixel 190, the transmissive and reflective regions 136 and 138 show bright and uniform white images 604a and 604b, respectively.

FIG. 11D shows an example simulated iso-contrast contour graph 608 of a display having pixels 190 of FIG. 10 and operating in the transmissive mode. The graph 608 simulates the viewing angles of the display in the transmissive mode without using any compensation films. The graph 608 shows that the display can achieve a 10:1 contrast ratio in the transmissive mode without grayscale inversion within a viewing cone greater than 60°.

FIG. 11E shows an example simulated iso-contrast contour graph 606 of a display having pixels 190 of FIG. 10 and operating in the reflective mode. The graph 606 simulates the viewing angles of the display in the reflective mode without using any compensation films. The graph 606 shows that the display can achieve a 10:1 contrast ratio in the reflective mode without grayscale inversion within a viewing cone greater than 45°. These viewing angles are adequate for displays used in, e.g., mobile devices.

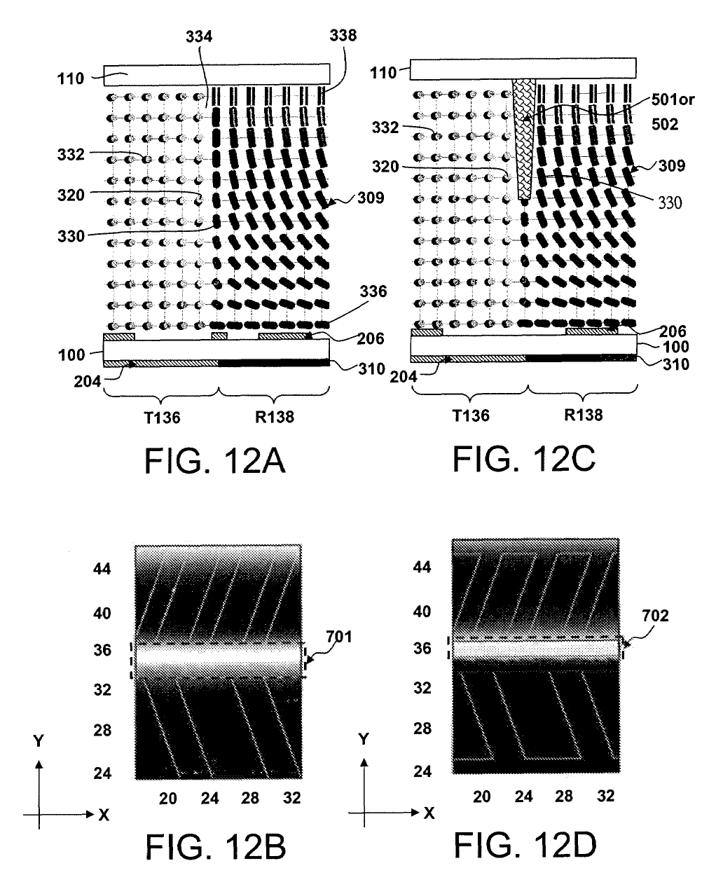

FIG. 12A shows example simulated liquid crystal orientations of a pixel in which a barrier wall is not used. The pixel structure used for generating the simulation in FIG. 12A is the same as the pixel 190 in FIG. 10. The pixel includes a reflector 310, a pixel electrode 204, a common electrode 206, and liquid crystals 309, similar to those in FIGS. 7A to 7D.

In the transmissive region 136, the liquid crystal molecules are oriented mostly parallel to the surface of the upper and lower substrates 110 and 100. In the reflective region 138, the liquid crystal molecules (e.g., 336) near the lower substrate 100 are mostly oriented parallel to the surface of the substrate 100, whereas the liquid crystal molecules (e.g., 338) near the upper substrate 110 are mostly oriented perpendicular to the surface of the substrate 110. Some of the liquid crystal molecules (e.g., 320) in the transmissive region 136 located near a boundary 334 of the T and R regions are influenced by the liquid crystal molecules (e.g., 330) in the R region 138. As a result, some of the liquid crystal molecules in the T region 136 near the boundary 334 tilt at angles larger than the liquid crystal molecules (e.g., 332) that are located farther away from the boundary 334, resulting in light leakage at the boundary 334.

FIG. 12B shows a simulated image shown by the pixel of FIG. 12A in a dark state. The pixel has a region 701 that has light leakage, which can be blocked by using a black matrix.

FIG. 12C shows example simulated liquid crystal orientations of a pixel in which a barrier wall is used. The pixel structure used for generating the simulation in FIG. 12C is the same as the pixel 220 in FIG. 8. In the simulation, the pixel includes a reflector 310, a pixel electrode 204, a common electrode 206, liquid crystals 309, and a patterned barrier wall layer 501 or 502, similar to those in FIG. 9A or FIG. 9B.

When a barrier wall 501 or 502 is used, the influence on the liquid crystal molecules (e.g., 320) in the T region 136 near the boundary 334 by the liquid crystal molecules (e.g., 330) in the R region 138 is reduced. The liquid crystal molecules (e.g., 320) in the T region 136 near the boundary 334 maintain substantially the same orientation as the liquid crystal molecules (e.g., 332) that are located farther away from the boundary between the T and R regions. As a result, the light leakage is reduced.

FIG. 12D shows a simulated image shown by the pixel of FIG. 12C in a dark state. The pixel has a region 702 that has light leakage, but the region 702 is smaller than the region 701 of FIG. 12B. The black matrix used to block the region 702 can have a smaller area than the black matrix used to block the region 701. Thus, by using the barrier wall 501 or 502, light leakage can be reduced, and the area of the black matrix can be reduced, increasing the aperture ratio of the display.

In some examples, the patterned barrier 501 or 502 can have a height H equal to about 0.4˜3.2 μm and a width W equal to about 3˜20 μm. In the example used to generate the simulations of FIGS. 12C and 12D, the barrier wall 501 or 502 has a height H equal to 1.8 μm and a width W equal to 5 μm.

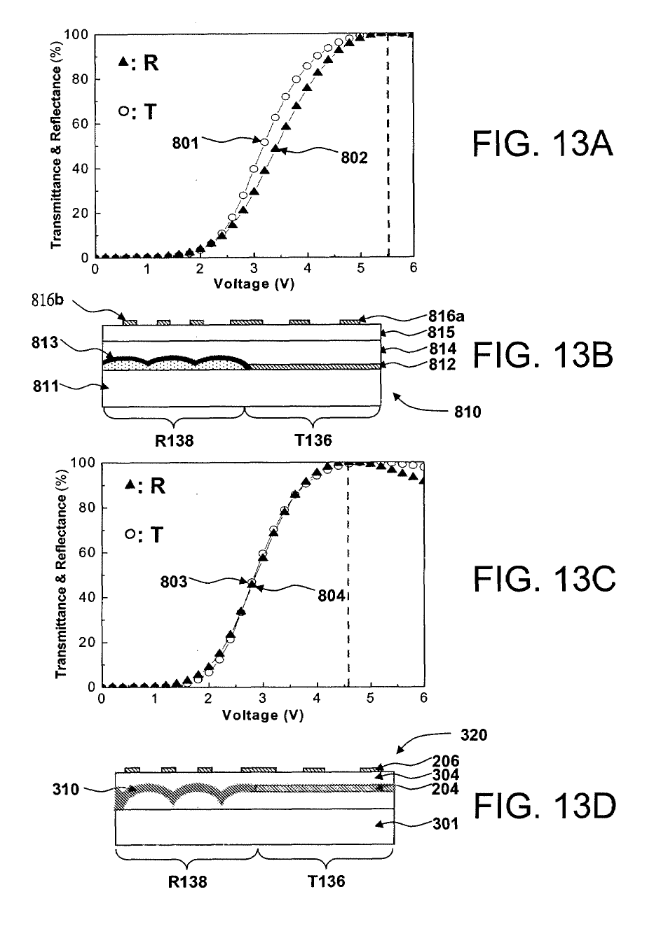

FIG. 13A shows an example simulated V-T curve 801 and an example simulated V-R curve 802 of a pixel 810, whose structure is shown in FIG. 13B. The pixel 810 includes an array substrate 811, a common electrode 812 that is connected to a reflector electrode 813, a pixel electrode 816, a gate insulator layer 814 and a passivation layer 815 to reduce the parasitic capacitance between the data line and the striped pixel electrodes. The total thickness of the insulation layer 814 and the passivation layer 815 is about 400 nm. The common electrode 812 has a planar shape, whereas the pixel electrode 816 has many stripes. The portion of the pixel electrode 816 in the T region 136 is referenced as 816a, and the portion of the pixel electrode 816 in the R region 138 is referenced as 816b. The electrode width and electrode spacing of the stripes of the pixel electrode 816 in the T region 136 and the R region 138 are different. The pixel electrode 816 is positioned between the common electrode 812 (and the reflector electrode 813) and the liquid crystal layer. As can be seen in FIG. 13A, the V-T curve 801 does not match the V-R curve 802 very well.

For the simulation of FIG. 13A, the pixel 810 has a single cell gap of 3.77 mm, and a negative dielectric liquid crystal material (MJ98468) is used. In the T region 136, the pixel electrode 816a has a width w=3 μm and an electrode spacing l=5 μm. In the R region 138, the pixel electrode 816b has a width w=2 μm and an electrode spacing l=3 μm.

FIG. 13C shows an example simulated V-T curve 803 and an example simulated V-R curve 804 of a pixel 320, whose structure is shown in FIG. 13D, in which a pixel-common inversion electrode structure is used. The common electrode 206 is positioned between the liquid crystal layer and the pixel electrode 204 (and the reflector electrode 310). The pixel 320 has a structure similar to the pixel shown in FIG. 7D.

For the simulation of FIG. 13C, the pixel 320 has a single cell gap of 3.77 μm, and a negative dielectric liquid crystal material (MJ98468) is used, similar to those used for the simulation of FIG. 13A. In the T region 136, the stripes of the common electrode 206 has a width w=3 μm and a spacing l=5 μm. In the R region 138, the stripes of the common electrode 206 has a width w=2 μm and a spacing l=3 μm. The pixel 320 includes an array substrate 301, a pixel electrode 204 that is connected to a reflector electrode 310, and a common electrode 206. An insulator layer 304 having a thickness of about 200 nm is positioned between the common electrode 206 and the pixel electrode 204 (and reflector electrode 310).

As shown in FIG. 13A, when the pixel 810 that includes insulators 814 and 815 having a thickness of 400 nm is used, the pixel driving voltage corresponding to the bright state (highest luminance) is about 5.5V. If the negative dielectric anisotropy liquid crystal material is replaced with a positive dielectric anisotropy liquid crystal material, the pixel driving voltage that corresponds to the bright state can be about 4.6V.

As shown in FIG. 13C, when the pixel 320 that includes the insulator layer 304 having a thickness of 200 nm is used, the pixel driving voltage that corresponds to the bright state is about 4.7V. The pixel-common electrode inversion electrode structure allows a thinner insulator layer 304 to be used, allowing the pixel driving voltage for the bright state to be reduced from about 5.5 V (as shown in FIG. 13A) to about 4.7 V (as shown in FIG. 13C). FIG. 13C also shows a good match between the curves 803 and 804, indicating that the display will have a good match in gray scale when operating in the transmissive and reflective modes. This allows the display to be driven with single gamma curve for both transmissive and reflective modes.

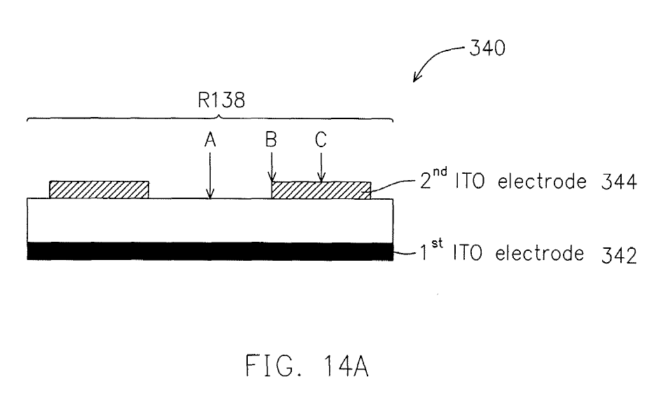

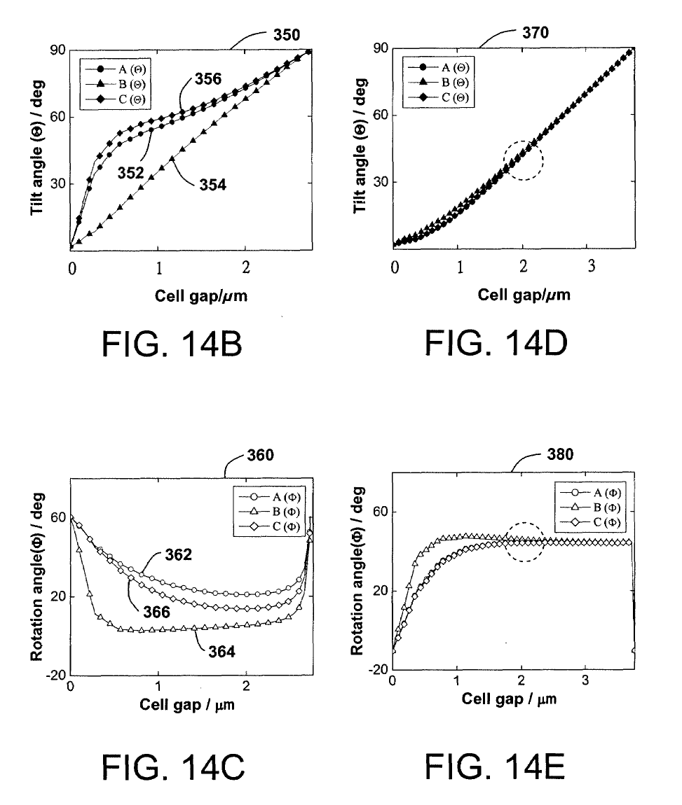

FIG. 14A shows a cross sectional diagram of an example reflective region 138 of a pixel 340. Relationships between liquid crystal molecule tilt angles and rotation angles at different locations in the reflective region 138, e.g., locations A, B, and C in FIG. 14A for different pixel structures are simulated. The simulation results are shown in FIGS. 14B to 14E. The pixel 340 includes a first ITO electrode 342 and a second ITO electrode 344. For the simulations shown in FIGS. 14B and 14C, the first ITO electrode 342 functions as a common electrode, and the second ITO electrode 344 functions as a reflector electrode. For the simulations shown in FIGS. 14D and 14E, the first ITO electrode 342 functions as a reflector electrode, and the second ITO electrode 344 functions as a common electrode.

FIG. 14B is a graph 350 showing simulated relationships between the tilt angle of liquid crystal molecules and the cell gap for cell gaps in a range between 0 to 3 μm. Curves 352, 354, and 356 represent relationships between the tilt angle and the cell gap at locations A, B, and C (FIG. 14A), respectively. The curves 352, 354, and 356 do not match very well.

FIG. 14C is a graph 360 showing simulated relationships between rotation angle of liquid crystal molecules and the cell gap for cell gaps in a range between 0 to 3 μm. Curves 362, 364, and 366 represent relationships between the rotation angle and the cell gap at locations A, B, and C (FIG. 14A), respectively. The curves 362, 364, and 366 do not match very well.

For the simulations in both FIGS. 14B and 14C, the pixel 340 (FIG. 14A) corresponds to the reflective region 138 of the pixel 810 in FIG. 13B. The first ITO electrode 342 functions as the common electrode 813 (FIG. 13B), and the second ITO electrode 344 functions as the reflector electrode 816b (FIG. 13B). The reflector electrode has many stripes, in which the electrode width w is 2 μm and the electrode spacing l is 3 μm. The cell gap is 2.77 μm, and a positive dielectric anisotropy liquid crystal material is used. The pixel includes an array substrate 811, a common electrode 812 that is connected to a reflector electrode 813, a pixel electrode 816a, a gate insulator 814, and a passivation layer 815. The insulation layers 814 and 815 between the pixel electrode 816a and the common electrodes 812 (and reflector electrode 816b) is 400 nm.

FIG. 14D is a graph 370 showing simulated relationships between the tilt angle of liquid crystal molecules and the cell gap for cell gaps in a range between 0 to 4 μm. The curves representing relationships between the tilt angle and the cell gap at locations A, B, and C (FIG. 14A) match well for cell gaps in a range from about 1.8 μm to 4 μm.

FIG. 14E is a graph 380 showing simulated relationships between rotation angle of liquid crystal molecules and the cell gap for cell gaps in a range between 0 to 4 μm. The curves represent relationships between the rotation angle and the cell gap at locations A, B, and C (FIG. 14A) match well for cell gaps in a range from about 1.8 μm to 3.8 μm.

For the simulations in both FIGS. 14D and 14E, the pixel 340 (FIG. 14A) corresponds to the reflective region 138 of the pixel 320 in FIG. 13D. The first ITO electrode 342 functions as the reflector electrode 310 (FIG. 13D), and the second ITO electrode 344 functions as the common electrode 206. The common electrode has many stripes, in which the electrode width w is 2 mm and the electrode spacing l is 3 mm. The cell gap is 3.77 μm, and a negative dielectric anisotropy liquid crystal material is used. The pixel includes an array substrate 301, a pixel electrode 204 that is connected to the reflector electrode 310, the common electrode 206, and an insulator layer 304. The insulator layer 304 has a thickness of 200 nm.

Comparing the simulation results in FIGS. 14B and 14C with those shown in FIGS. 14D and 14E indicates that using the pixel-common inversion electrode structure (shown in FIG. 13D) and a negative dielectric liquid crystal material results in the same (or almost the same) tilt angles and rotation angles for the whole pixel area (e.g., locations A, B, and C in FIG. 14A) for cell gaps ranging from about 1.8 μm to 3.8 μm. A pixel using the pixel-common inversion electrode structure and a negative dielectric anisotropy liquid crystal material can achieve a uniform high reflectance in the reflective region 138.

The transflective LCD using pixel structures shown in FIGS. 3, 4, 6-10, and 13D can have one or more of the following advantages.
A single cell gap can be used for the transmissive region 136 and the reflective region 138 of the transflective pixel. Manufacturing processes can be simplified, and the display can have a higher contrast performance.
A wide viewing angle can be achieved. The fringe field switching liquid crystal display using the pixel-common inversion electrode structure can achieved a 10:1 contrast ratio without grayscale inversion within a viewing cone greater than 60° in the transmissive mode, and over within a viewing cone greater than 45° in the reflective mode, both without using any compensation films. The viewing angles are adequate for various applications, such as for use in mobile devices.
A high transmittance and a high reflectance can be achieved. By using a barrier wall (e.g., 501 of FIG. 9A or 502 of FIG. 9B), the display can use a black matrix with a small area so each pixel can have a high aperture ratio. A maximum transmittance of about 80% and a maximum reflectance of about 90% can be achieved. The display can have a good match between V-T and V-R characteristics so that the pixels can be driven using a single gamma curve. The matching between the V-T and V-R characteristics can be achieved by using, e.g., a negative dielectric anisotropy liquid crystal material, a pixel-common inversion electrode structure, a common electrode with stripes, and a hybrid aligned nematic cell configuration in the reflective region.
A low pixel driving voltage can be used. By using the pixel-common inversion electrode structure, a thin insulator layer can be used between the common electrode and the pixel electrode (and the reflector electrode), so that a low pixel voltage can be used to drive the pixel. For example, in the bright state, the operation voltage can be about 5.0 Vrms in the transmissive mode and about 4.6 Vrms in the reflective mode.
It is not necessary to use compensation layers or in-cell retarders to achieve a good viewing angle. This simplifies the fabrication process for producing the display.

Other embodiments are within the scope of the following claims. Additional layers can be used in the displays described above. The components of the displays, such as the liquid crystal layer, the polarization films, and the alignment layers, can use materials and have parameters different from those described above. The common electrode 105 does not necessarily have to be connected to a ground reference voltage. When the display is operating in the transmissive mode in which the backlight unit 130 is turned on, some ambient light may be reflected by the reflective pixel electrode, so the display can operate in both the transmissive and reflective modes at the same time. The electrode widths and electrode spacing can be different from those described above. The geometry of the common electrode can be different from those shown in FIGS. 6, 8, and 10. For example, the openings and the stripes in the common electrode can have varying widths, can be curved, and can have various shapes. In the example of FIG. 9A, the pigment layer 307 is a red pigment layer, and the barrier wall 501 includes overlapping layers of blue and green pigment layers. The pigment layer 307 can be a green pigment layer, in which the barrier wall 501 includes overlapping layers of red and blue pigment layers. The pigment layer 307 can also be a blue pigment layer, in which the barrier wall 501 includes overlapping layers of red and green pigment layers.

The orientations of the liquid crystal molecules described above refer to the directions of directors of the liquid crystal molecules. The molecules do not necessarily all point to the same direction all the time. The molecules may tend to point more in one direction (represented by the director) over time than other directions. For example, when we say the liquid crystal molecules are aligned along a particular direction, we mean that the average direction of the directors of the liquid crystal molecules is generally aligned along the particular direction, but the individual molecules may point to different directions. When we say the liquid crystal molecules in the transmissive region has a homogeneous alignment, we mean that the average direction of the directors of the liquid crystal molecules in the transmissive region is generally aligned along the same direction, but the individual molecules may point to different directions.

What is claimed is:

1. A liquid crystal display, comprising:
an upper substrate;
a lower substrate that is closer to a backlight unit than the upper substrate;
a liquid crystal layer between the lower and upper substrates, the liquid crystal layer comprising liquid crystal molecules having a negative dielectric anisotropy;
pixels between the upper and lower substrates, each pixel having a transmissive region and a reflective region in which the transmissive region has a cell gap substantially the same as the cell gap of the reflective region, the transmissive region having a transparent pixel electrode, the reflective region having a reflective pixel electrode;
an upper alignment layer between the upper glass substrate and the liquid crystal layer;
a lower alignment layer between the lower substrate and the liquid crystal layer, the upper and lower alignment layers oriented such that the liquid crystal molecules are homogeneously aligned in the transmissive region, and the liquid crystal molecules have a hybrid alignment in the reflective region, in which liquid crystal molecules closer to the lower substrate are aligned in a direction different from the liquid crystal molecules closer to the upper substrate; and
a common electrode in which the common electrode and the pixel electrode are at a same side relative to the liquid crystal layer, and the orientation of the liquid crystal molecules are controlled based on fringe electric fields generated by the pixel and common electrodes when a voltage difference is applied between the pixel electrode and the common electrode.

2. The liquid crystal display of claim 1 in which in the transmissive region, the common electrode is between the liquid crystal layer and the transparent pixel electrode, and in the reflective region, the common electrode is between the liquid crystal layer and the reflective pixel electrode.

3. The liquid crystal display of claim 1 in which the transparent pixel electrode and the reflective pixel electrode are electrically connected and receive a pixel voltage that corresponds to a gray level to be shown by the pixel.

4. The liquid crystal display of claim 1, further comprising a first linear polarizer coupled to the lower substrate, and a second linear polarizer coupled to the upper substrate, in which the transmission axis of the first and second linear polarizers are substantially perpendicular to each other.

5. The liquid crystal display of claim 4 in which in the transmissive region the alignment directions of the upper and lower alignment layers are substantially parallel to the transmission axis of one of the first and second linear polarizers, and the alignment direction of the lower alignment layer in the reflective region is at an angle in a range of 30° to 60° with respect to the transmission axis of one of the first and second linear polarizers.

6. The liquid crystal display of claim 1 in which the common electrode in the transmissive region comprises stripes, the common electrode in the reflective region comprises stripes, and the stripes of the common electrode in the transmissive region are at an angle in a range of 120° to 160° relative to the stripes of the common electrode in the reflective region.

7. The liquid crystal display of claim 6, wherein the stripes of the common electrode in the transmissive region and the stripes of the common electrode in the reflective region have a chevron geometry.

8. The liquid crystal display of claim 1 in which the common electrode in the reflective region comprises stripes each having a width in a range from 1 to 3 μm and a spacing between stripes in a range from 2 to 4 μm, and the common electrode in the transmissive region comprises stripes each having a width in a range from 2 to 4 μm and a spacing between stripes in a range from 4 to 6 μm.

9. The liquid crystal display of claim 1, comprising data bus lines made of conductive metals comprising at least one of MoW, an alloy Al—Nd, or a stacked layer of Mo/Al materials, each data bus line having a chevron shape in a pixel region and is covered and electrically shielded by a common electrode stripe from the liquid crystal layer.

10. The liquid crystal display of claim 1, wherein in the transmissive region, the common electrode comprises stripes, and the surface alignment direction of the liquid crystal layer is at an angle in a range between 5° to 20° with respect to a direction perpendicular to the common electrode stripes.

11. The liquid crystal display of claim 10 in which in the transmissive region, the surface pretilt angles of the liquid crystal layer on both the lower and upper substrates are in a range between 0° to 10° relative to respective substrate surfaces.

12. The liquid crystal display of claim 1, wherein in the reflective region, the common electrode comprises stripes, the surface alignment direction of the liquid crystal layer on the lower substrate is at an angle in a range between 5° to 20° with respect to a direction perpendicular to the common electrode stripes, and the surface pre-tilt angle of the liquid crystal layer on the upper substrate is in a range between 85° to 90° relative to a surface of the upper substrate.

13. The liquid crystal display of claim 12 in which in the reflective region, the surface pretilt angle of the liquid crystal layer on the lower substrate is in a range between 0° to 10° relative to the lower substrate surface.

14. The liquid crystal display of claim 1, wherein a black matrix is formed on the upper substrate covering a thin film transistor area and a boundary area between the transmissive region and the reflective region.

15. The liquid crystal display of claim 1, comprising a barrier wall between the transmissive region and the reflective region.

16. The liquid crystal display of claim 15 in which the barrier wall has a height substantially the same as a thickness of the liquid crystal layer and defines a cell gap of the liquid crystal layer.

17. The liquid crystal display of claim 15 in which the barrier wall comprises color resin.

18. The liquid crystal display of claim 15, wherein the barrier wall comprises a dielectric layer.

19. The liquid crystal display of claim 15, wherein the barrier wall has a height in a range from 0.4 to 3.2 μm and a width in a range from 3 to 20 μm.

20. The liquid crystal display of claim 15, wherein the barrier wall has a height that is between 10% to 90% of a cell gap of a liquid crystal layer of the pixel.

21. A display comprising:
a pixel having a transmissive region and a reflective region,
the transmissive region having
a liquid crystal layer between a first substrate and a second substrate, the liquid crystal layer comprising liquid crystal molecules that are aligned substantially along a same direction when the pixel is in a dark state,
a transparent pixel electrode, and
a common electrode in which the transparent pixel electrode and the common electrode are at a same side relative to the liquid crystal layer, and orientation of the liquid crystal molecules is controlled based on fringe electric fields generated by the transparent pixel electrode and common electrode when a voltage difference is applied between the transparent pixel electrode and the common electrode;
the reflective region having
a liquid crystal layer between the first substrate and the second substrate, the liquid crystal layer having a hybrid alignment in which liquid crystal molecules closer to the first substrate are aligned in a direction different from the liquid crystal molecules closer to the second substrate when the pixel is in the dark state;
a reflective pixel electrode, and
a common electrode in which the reflective pixel electrode and the common electrode are at the same side relative to the liquid crystal layer such that orientation of the liquid crystal molecules is controlled based on fringe electric fields generated from the reflective pixel electrode when a voltage difference is applied between the reflective pixel electrode and the common electrode.

22. The display of claim 21 in which the common electrode of the transmissive region is electrically coupled to the common electrode of the reflective region.

23. The display of claim 21 in which the transparent pixel electrode of the transmissive region is electrically coupled to the reflective pixel electrode of the reflective region.

24. The display of claim 21 in which the common electrode is between the transparent pixel electrode and the liquid crystal layer.

25. A liquid crystal display, comprising:
pixels, each comprising
a transmissive region having a liquid crystal layer that has a homogeneous alignment, the transmissive region having an alignment layer, a common electrode, and a pixel electrode that are on a same side of the liquid crystal layer, and
a reflective region having a liquid crystal layer that has a hybrid alignment, the reflective region having an alignment layer, a common electrode, and a reflective pixel electrode that are on a same side of the liquid crystal layer, in which the alignment layer of the reflective region has an alignment direction that is different from that of the alignment layer of the transmissive region.

26. The liquid crystal display of claim 25 in which in the common electrode comprises stripes in the transmissive region and the reflective region.

27. The liquid crystal display of claim 26 in which the common electrode stripes in the reflective region extend along a first direction, and the common electrode stripes in the transmissive region extend along a second direction that is different from the first direction.

28. The liquid crystal display of claim 27 in which the first direction is at an angle between 20° to 60° relative to the second direction.

29. The liquid crystal display of claim 26 in which the common electrode stripes in the reflective region have a stripe width and a stripe spacing that are different from those of the common electrode stripes in the transmissive region.

30. The liquid crystal display of claim 29 in which the reflective and transmissive regions have common electrode stripes with stripe widths and stripe spacing that are configured to cause a voltage-transmittance curve to match a voltage-reflectance curve.

31. The liquid crystal display of claim 25 in which when a pixel voltage corresponding to a dark state is applied between the reflective pixel electrode and the common electrode, the liquid crystal layer in the reflective region functions as a quarter wave plate.

32. The liquid crystal display of claim 25 in which when a pixel voltage corresponding to a bright state is applied between the reflective pixel electrode and the common electrode, the liquid crystal layer in the reflective region is driven to have its effective optic axis rotated about 45° away from its initial alignment direction.
